(19) United States
(12) Patent Application Publication
(10) Pub. No.: US 2014/0019378 A1
(43) Pub. Date: Jan. 16, 2014

(54) EVALUATION SYSTEM, METHOD, AND COMPUTER-READABLE RECORDING MEDIUM

(71) Applicants: Taro OKUYAMA, Tokyo (JP); Yuuji Kasuya, Kanagawa (JP); Kiwamu Watanabe, Kanagawa (JP); Zhi Min, Saitama (JP); Taiji Shudoh, Kanagawa (JP)

(72) Inventors: Taro OKUYAMA, Tokyo (JP); Yuuji Kasuya, Kanagawa (JP); Kiwamu Watanabe, Kanagawa (JP); Zhi Min, Saitama (JP); Taiji Shudoh, Kanagawa (JP)

(73) Assignee: RICOH COMPANY, LTD., Tokyo (JP)

(21) Appl. No.: 13/936,356

(22) Filed: Jul. 8, 2013

(30) Foreign Application Priority Data
Jul. 10, 2012 (JP) 2012-154273

(51) Int. Cl. G06Q 30/02

(52) U.S. Cl. CPC G06Q 30/0282
USPC 705/347

(57) ABSTRACT

An evaluation system includes an evaluation device and a server. The evaluation device includes a detection unit configured to detect a specific action, an ID (identification data) obtaining unit configured to obtain an ID of an evaluation object according to a detection result of the detection unit, a first storage unit configured to store the ID obtained by the ID obtaining unit, and a communication unit configured to transmit the ID to a server and receive evaluation data of the evaluation object from the server. The server includes a second storage unit configured to store the evaluation data of the evaluation object in association with the ID of the evaluation object, a counting unit configured to update the evaluation data of the evaluation object when receiving the ID associated with the evaluation object, and a providing unit configured to transmit the evaluation data to the evaluation device.

### BACKGROUND OF THE INVENTION

1. Field of the Invention

The present invention relates to an evaluation system, a method, and a computer-readable recording medium.

2. Description of the Related Art

Providers of products and services perform various kinds of sales promotion activities for promoting their products and services. Owing to the advance of communication technology, it is now possible for consumers, customers, and other entities receiving the products and services (hereinafter simply referred to as “evaluators”) to evaluate or rate the products and services, so that their evaluation results (ratings) can be shared by the evaluators through a Web site or the like. For example, there is a Web site that allows a review of a specific product to be submitted by a given evaluator. A potential consumer interested in a product/service tends to value not only the information provided by the provider but also the evaluation results of the evaluators.

On the Internet, there is a known technology of disclosing various evaluation results provided by a given evaluator (see, for example, Japanese Laid-Open Patent Publication No. 2011-96259). Japanese Laid-Open Patent Publication No. 2011-96259 teaches evaluating a message by pressing a predetermined button, reporting the evaluation to the sender of the message, and displaying the results of the evaluation on a list.

### SUMMARY OF THE INVENTION

The present invention may provide an evaluation system, a method, and a computer-readable recording medium that substantially obviate one or more of the problems caused by the limitations and disadvantages of the related art.

Features and advantages of the present invention are set forth in the description which follows, and in part will become apparent from the description and the accompanying drawings, or may be learned by practice of the invention according to the teachings provided in the description. Objects as well as other features and advantages of the present invention will be realized and attained by an evaluation system, a method, and a computer-readable recording medium particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides an evaluation system including an evaluation device and a server. The evaluation device includes a detection unit configured to detect a specific action, an ID (identification data) obtaining unit configured to obtain an ID of an evaluation object according to a detection result of the detection unit, a first storage unit configured to store the ID obtained by the ID obtaining unit, and a first communication unit configured to transmit the ID to a server and receive evaluation data of the evaluation object from the server. The server includes a second storage unit configured to store the evaluation data of the evaluation object in association with the ID, a counting unit configured to update the evaluation data of the evaluation object when receiving the ID associated with the evaluation object, and a transmission unit configured to transmit the evaluation data to the evaluation device.

Other objects, features and advantages of the present invention will become more apparent from the following detailed description when read in conjunction with the accompanying drawings.

### BRIEF DESCRIPTION OF THE DRAWINGS

FIGS. 1A-2C are schematic diagrams for describing an evaluation system according to an embodiment of the present invention;

FIG. 3 is a schematic diagram illustrating an example of a configuration of an evaluation system according to an embodiment of the present invention;

FIG. 4 is a schematic diagram illustrating an example of a hardware configuration of an evaluation device according to an embodiment of the present invention;

FIG. 5 is a schematic diagram illustrating an example of a hardware configuration of a server according to an embodiment of the present invention;

FIGS. 6A-6B are functional block diagrams of an evaluation system including an evaluation device according to an embodiment of the present invention;

FIG. 7A is a schematic diagram illustrating an example where an ID is displayed on a display unit according to communication of a communication unit according to an embodiment of the present invention;

FIG. 7B is a schematic diagram illustrating an example where an ID is selected according to radio wave strength according to an embodiment of the present invention;

FIG. 8A illustrates an example of an evaluation result table stored in an evaluation data management DB according to an embodiment of the present invention;

FIG. 8B illustrates an example of an object identifying table stored in an evaluation data management DB according to an embodiment of the present invention;

FIGS. 9A-9B are schematic diagrams illustrating a top page displayed on a browser client according to an embodiment of the present invention;

FIGS. 10A-10C are flowchart for describing a procedure of evaluating an evaluation object with an evaluation device according to an embodiment of the present invention;

FIG. 11 is a flowchart illustrating a process of detecting a gesture action with an action detection unit according to an embodiment of the present invention;

FIG. 12 illustrates a flowchart of a procedure of transmitting an ID from an evaluation device to a server and receiving an evaluation number from the server according to an embodiment of the present invention;

FIG. 13A is a schematic diagram illustrating an example where an evaluation number is displayed in a display unit of an evaluation device according to an embodiment of the present invention;

FIG. 13B is a schematic diagram illustrating an example where a position of a wireless communication chip is displayed in a display unit of an evaluation device according to an embodiment of the present invention;

FIG. 14 illustrates a flowchart of a procedure of transmitting a browse request from a browser client to a server and receiving evaluation data including an evaluation number from the server according to an embodiment of the present invention;

FIGS. 15A-16C are schematic diagrams for describing an evaluation system according to a second embodiment of the present invention;

FIG. 17 is a schematic diagram illustrating an example of a configuration of an evaluation system according to the second embodiment of the present invention;

FIGS. 18A and 18B are functional block diagrams for describing an evaluation system including an evaluation device according to the second embodiment of the present invention;

FIG. 19 is a schematic diagram illustrating an example of an image data DB according to an embodiment of the present invention;

FIG. 20 is a schematic diagram for describing visual search according to an embodiment of the present invention:

FIGS. 21A and 21B are schematic diagrams for describing an example of a word boundary box determination algorithm according to an embodiment of the present invention;

FIG. 22 is a schematic diagram for describing a grouping process based on word boundaries according to an embodiment of the present invention;

FIG. 23 is a schematic diagram for describing feature quantities including feature quantities “0” and “1” according to an embodiment of the present invention;

FIG. 24 is a schematic diagram for describing an example of calculating angles formed by word boundaries according to an embodiment of the present invention;

FIG. 25 is a schematic diagram for describing a feature quantity based on word length according to an embodiment of the present invention;

FIGS. 26A-26E are schematic diagrams for describing how a vertical layout is combined with a horizontal layout according to an embodiment of the present invention;

FIG. 27 is an example for describing a method of combining data of horizontal trigrams and vertical trigrams obtained in FIGS. 26A-26E; and

FIG. 28 is a flowchart illustrates an example of a procedure for transmitting image data from an evaluation device to a search server according to an embodiment of the present invention.

### DETAILED DESCRIPTION OF THE PREFERRED EMBODIMENTS

According to a related art example, the evaluator's evaluation on a product or a service is limited to information provided on a Web site. Further, in a case of submitting a evaluation (rating) regarding a specific product, a Web site dedicated for the specific product is prepared beforehand.

Further, there is also a technology of determining an evaluator's evaluation results regarding not only data on a Web site but also an object existing in reality (see, for example, Japanese Patent No. 4753616). Japanese Patent No. 4753616 teaches a product data providing system that performs analyzing the types of action taken by a customer (e.g., taking a product into hand, returning a product, carrying a product to a fitting room, buying a product, not buying a product) by way of an IC tag attached to a product and an antenna that identifies the IC tag, associating the actions with the customer or time, assuming the associated actions to be a single series of purchasing actions, compiling the actions based on the types of actions included in the series of purchasing actions in view of the settings and weighting performed beforehand by an input/output unit, and transmitting the compiled results, the types of actions, or purchasing actions to the input/output unit in accordance with request from the input/output unit.

However, with the product data providing system disclosed in Japanese Patent No. 4753616, the customer cannot actively provide an evaluation result of a product. In other words, the product data providing system disclosed in Japanese Patent No. 4753616 automatically evaluates the actions taken by the customer and does not take the customer's intended evaluation into consideration.

Further, with the product data providing system disclosed in Japanese Patent No. 4753616, the evaluation data is managed by the seller. Thus, the customer cannot determine whether the customer's evaluation has been appropriately handled or confirm the customer's evaluation results.

Further, even in a case where a customer does not actually purchase a product, the seller can gather data on hot-selling products and services by compiling data obtained from a questionnaire or the like and utilize the compiled data for marketing. However, with the method of compiling data obtained from questionnaires and the like, the customer cannot determine whether the customer's evaluation has been appropriately handled or confirm the customer's evaluation results.

Next, embodiments of the present invention are described with reference to the accompanying drawings.

### First Embodiment

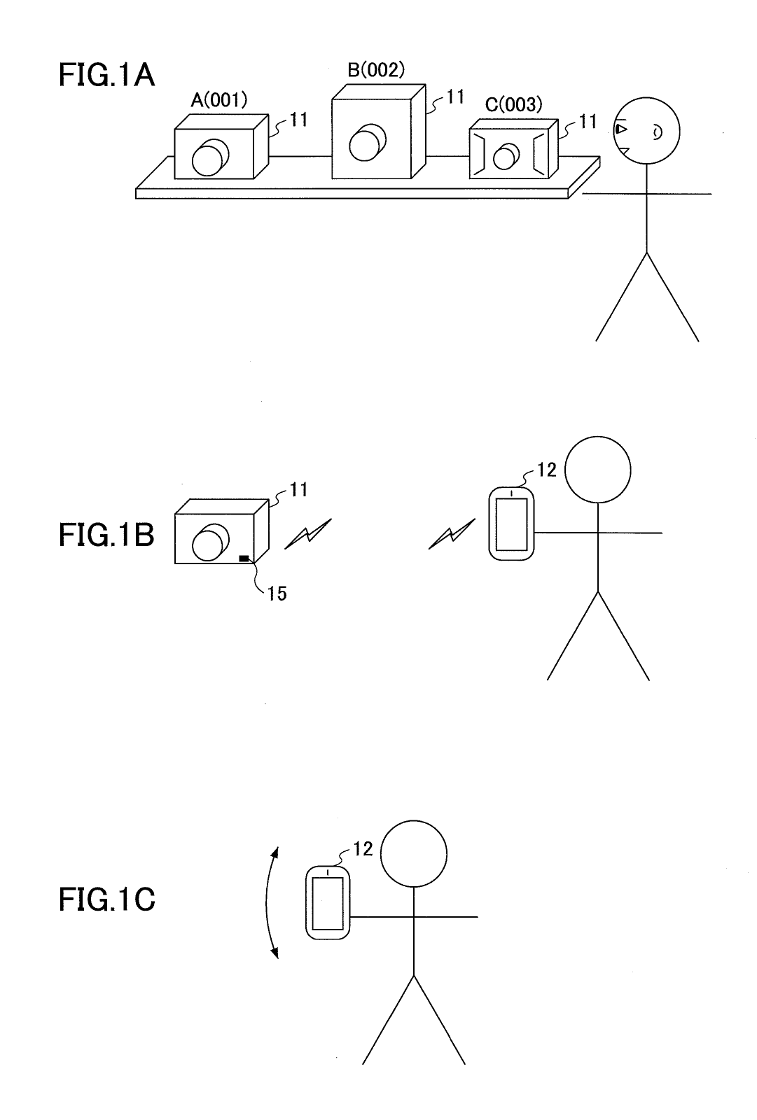

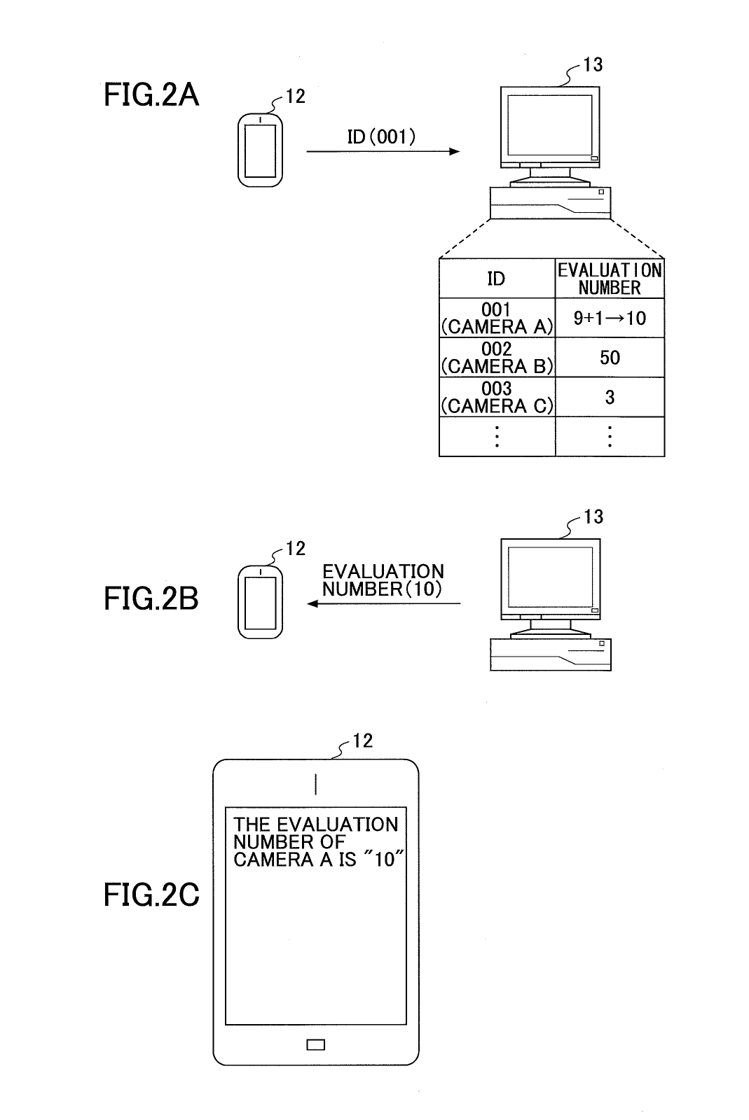

FIGS. 1A-2C are schematic diagrams for describing an evaluation system 500 according to an embodiment of the present invention.

An evaluator is carrying an evaluation device 12 (FIGS. 1B and 1C). The evaluation device 12 is, for example, a portable type communication terminal. In reality, when the evaluator finds an evaluation object 11 of interest while moving (traveling), the evaluator usually slows down or stops. As described below, the evaluation object 11 does not need to be evaluated (rated) before being purchased and may be evaluated (rated) after being purchased by the evaluator.

In FIG. 1B, the evaluation device 12 continues to detect one or more evaluation objects 11 that can perform wireless communication. In a case where there is an evaluation object 11 that can perform wireless communication with the evaluation device 12 is detected, the evaluation device 12 performs communication with the evaluation object 11 and receives an ID of the evaluation object 11. The ID of the evaluation object 11 is identification data that allows the evaluation object 11 to be identified.

Then, in FIG. 1C, in a case where the evaluator wishes to evaluate the evaluation object 11 of interest, the evaluator performs a specific action (movement) that is determined beforehand. The specific action (movement) may be any kind of action performed by the evaluator as long as the action is performed according to the will of the evaluator during evaluation by the evaluator. That is, the specific action cannot be an action that is unconsciously performed by the evaluator. The specific action may be, for example, moving the evaluation device 12 within a certain space (gesture), speaking into the evaluation device 12 (audio input), or operating (maneuvering) the evaluation device 12.

Then, in FIG. 2A, the evaluation device 12 transmits the ID of the evaluation object 11 to a server 13 when the evaluation device 12 detects the specific action. The server 13 identifies the evaluation object 11 based on the ID and counts an evaluation number of the evaluation object 11. In this embodiment, the counting of the evaluation number is to count up (also referred to as “add” or “increment”) the number of evaluations of the ID whenever the server 13 receives the ID. For example, in FIG. 2A, the evaluation number of the camera A is counted up from “9” to “10”. In a case where a corresponding ID is not found in the server 13, a new ID is registered in the server 13, and the evaluation number corresponding to the new ID is incremented to “1”.

Accordingly, in a case where the server 13 counts a large evaluation number for a particular evaluation object 11, it means that the particular evaluation object 11 is being evaluated by many evaluators. Further, in a case where the “evaluation” indicates a “positive” evaluation (rating), it means that the particular evaluation object 11 is being positively evaluated (rated) by many evaluators.

Then, in FIG. 2B, the server 13 transmits the newest (latest) evaluation number to the evaluation device 12. Although the server 13 may transmit only the evaluation number corresponding to the ID received from the evaluation device 12, the server 13 may additionally transmit the evaluation number of similar products or services in relation to the ID. Further, in a case where the server 13 has received the same ID from another evaluator in the past, the server 13 may transmit the newest evaluation number corresponding to the ID to the evaluator that had transmitted the ID in the past.

Then, in FIG. 2C, the evaluation device 12 displays the received evaluation number on its display part. In the example illustrated in FIG. 2C, the evaluation device 12 displays “The evaluation number of camera A is 10” on its display part.

With the evaluation system according to an embodiment of the present invention, the evaluator can actively evaluate a product/service of interest and confirm his/her evaluation results (ratings) in a reality space.

### (Configuration)

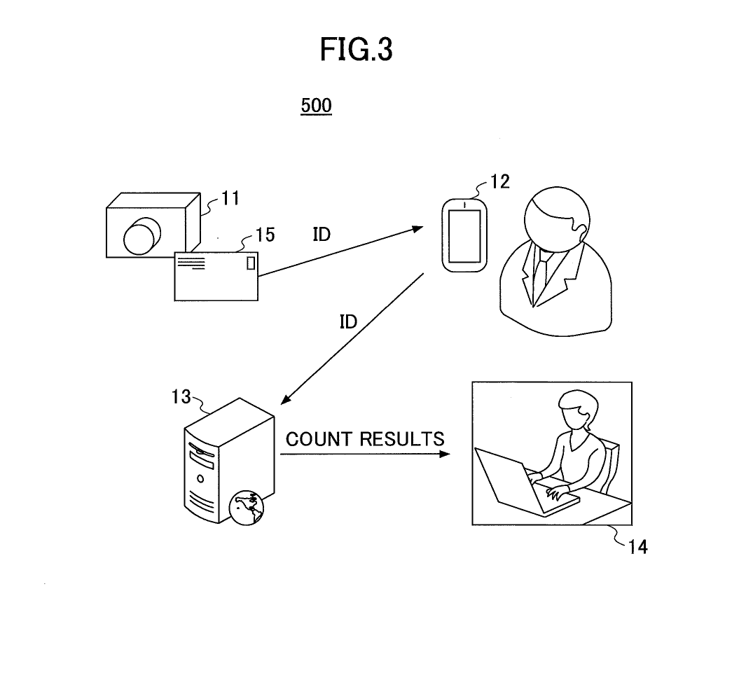

FIG. 3 is a schematic diagram illustrating an example of a configuration of an evaluation system 500 according to an embodiment of the present invention. The evaluation system 500 includes the evaluation object (including wireless communication chip 15) 11, the evaluation device 12, and the server 13. A browser client 14 may also be included in the evaluation system 500. In this embodiment, although a person that carries the evaluation device 12 is referred to as “evaluator”, the evaluator may be a random person or a specific qualified person.

### (Evaluation Object and Wireless Communication Chip)

In this embodiment, the wireless communication chip 15 is included in the evaluation object 11. The wireless communication chip 15 may be, for example, an IC tag using RFID (Radio Frequency Identification). The IC tag may be a relatively small chip having an antenna. At least an ID is stored in the IC tag. When the IC tag receives a radio wave or an electromagnetic wave, the IC tag reads out an ID and transmits the ID in response to received the radio wave or the electromagnetic wave. Alternatively, the IC tag may voluntarily transmit the ID.

In this embodiment, the wireless communication chip 15 can be regarded as the same as the evaluation object 11. That is, the wireless communication chip 15 is physically integrated with the evaluation object 11. Thus, it is difficult to separate the wireless communication chip 15 and the evaluation object 11 from each other. It is, however, to be noted that, the physical integration or the separation difficulty between the wireless communication chip 15 and the evaluation object 11 are not requisite.

The wireless communication chip 15 may be formed three-dimensionally by using, for example, a semiconductor manufacturing process. The three-dimensional wireless communication chip 15 may be adhered to a surface of a three-dimensional or a two-dimensional object or buried in the three-dimensional or two-dimensional object. Alternatively, the wireless communication chip 15 may be formed two-dimensionally by using, for example, a printing method such as screen printing, flexographic printing, or inkjet printing. The two-dimensional wireless communication chip 15 may be directly formed on a surface of a three-dimensional or two-dimensional object or formed on an adhesive material or the like and adhered to the surface of a three-dimensional or a two-dimensional object.

The wireless communication chip 15 includes various types of IC tags. For example, the wireless communication chip 15 may be a passive type IC tag that does not include a battery, an active type IC tag that includes a battery and voluntarily transmits radio waves, or a semi-active type IC tag that includes a battery but does not voluntarily transmit radio waves. Although wireless frequency bands may be different depending on the standards of a country or a region, the wireless frequency bands used for the wireless communication chip 15 is not limited to a particular frequency band. For example, the frequency band may be, 135 kHz or less, 13.56 MHz, a UHF (Ultra High Frequency) band (860 M to 960 M), or 2.45 GHz. Further, an IC tag complying to a specific standard (e.g., NFC (Near Field Communication, Transfer-Jet (registered trademark)) may be used as the wireless communication chip 15.

For example, in a case where an active type IC tag or a semi-active type IC tag us used as the wireless communication chip 15, the communication distance of the wireless communication chip 15 reaches to approximately 100 meters. Further, in a case where a passive type IC tag communicating with a UHF band frequency is used as the wireless communication chip 15, the communication distance of the wireless communication chip 15 reaches to 10 meters or more. Therefore, these types of IC tags are effective in a case of evaluating the evaluation object 11 that is far from the evaluator. On the other hand, in a case where an IC tag communicating with a frequency of 13.56 MHz is used as the wireless communication chip 15, the communication distance of the wireless communication chip 15 is only a few centimeters. Therefore, this type of IC tag is effective in a case where an evaluator wishes to selectively evaluate a specific evaluation object 11 amongst a vast number of evaluation objects 11.

The ID is identification data including a number, a symbol, an alphabet letter, or a combination of a number, a symbol, and/or an alphabet letter. For example, an ID of a product may be a JAN (Japanese Article Number) code, a EAN (European Article Number) code, or a UPC (Universal Product Code). Although it is preferable for the ID to be unique identification data that can be used worldwide, nationwide, or in a particular country or region, the ID may overlap depending on the size of the evaluation system 500 because the ID is assigned by the provider of the evaluation object 11. However, data of the evaluation object 11 other than the ID may also be stored in the IC tag. That is, given data for facilitating management is stored in the IC tag. For example, data such as a product name, a provider name, a product size, a color, a lot number may be stored in the IC tag. Therefore, it is rare for an ID and other data stored in the IC tag to match (overlap) with those of another IC tag. Thus, in a case where there is an overlap of IDs, the server 13 determines whether there is a match of other data stored in the IC tags. In a case where the other data stored in the IC tags do not match, the server 13 determines that the ID corresponds to another evaluation object 11. In a case where there is such an overlap, the server 13 may assign a branch number to the evaluation object 11 in addition to the ID of the evaluation object 11, so that evaluation objects 11 can be uniquely managed by the server 13.

In a case where the evaluation system 500 is used within a specific range (area) such as an exhibition hall or a particular area of a department store, the evaluation system 500 need only count evaluation numbers within the specific range. Therefore, in this case, the ID of the evaluation object 11 needs only to be unique within the specific range such as within the bounds of an exhibition hall or a particular area of a department store.

Alternatively, instead of communicating by way of an IC tag, the wireless communication chip 15 may communicate by way of Bluetooth (registered trademark) or a wireless LAN (Local Area Network).

As long as the evaluation object 11 is provided with the wireless communication chip 15, the evaluation object 11 may be a tangible object, an intangible object, or both. In a case where the evaluation object 11 is a tangible object, the evaluation object 11 may be various objects such as a product, a show piece, a lent object, one or another's personal belongings (property), an object that is simply placed somewhere, a waste article, an object fixed to a road, or a building. Although an intangible object alone (e.g., a service, a tourist site, a view, a place, a space) cannot serve as the evaluation object 11, an intangible object can serve as the evaluation object 11 and be evaluated if the intangible object is associated to a tangible object, so that the wireless communication chip 15 can be provided or arranged to the tangible object associated to the intangible object. For example, the service may be a restaurant business, a beauty salon business, a sanitation business, a repairing business, a human resource business, an education business, a transportation business, an infrastructure business, a public service (e.g., ward office, municipal office), or a medical business. In a case where the evaluation object 11 is a service, the provider of the service can arrange the wireless communication chip 15 at the place for providing the service, or the original place of a shop name, a table of a store, a cashier counter, or a terminal used by an employee. In a case where the evaluation object 11 is a tourist site, a view, a place, or a space, the wireless communication chip 15 may be arranged at a nearest station, a nearest bus stop, or a sign for explaining a tourist site.

### (Evaluation Device)

The evaluation device 12 may be any kind of communication device as long as the communication device can communicate with the wireless communication chip 15 and the server 13. In a case where the evaluation device 15 is, for example, a smart phone, a tablet, a straight PC, a mobile phone, a PDA (Personal Digital Assistant), a notebook PC (Personal Computer), the evaluator is likely to carry around the evaluation device 12 quite frequently. Thus, the evaluator is not limited to performing evaluation from only a specific evaluation device 12. Further, as described below, the evaluator evaluates the evaluation object 11 by performing a specific action. Therefore, a device that has a shape or a configuration enabling the evaluator to easily perform the specific action may be used as the evaluation device 12. For example, in a case where the evaluation device 12 is a baton (wand), the evaluator can evaluate the evaluation object 11 by simply flicking the baton downward. In a case of evaluating, for example, an exhibition hall, a name tag provided to the participants may be used as the evaluation device 12.

In this embodiment, the evaluation device 12 periodically searches for the wireless communication chip 15. When the evaluation device 12 detects the wireless communication chip 15, the evaluation device 12 receives an ID of the evaluation object 11 from the wireless communication chip 15. The wireless communication chip 15 may record data indicating the transmission of the ID therein. After receiving the ID, the evaluation device 12 transmits the ID to the server 13 when the evaluation device 12 detects the specific action of the evaluator. In a case where the specific action is not detected after receiving the ID, the ID of the evaluation device 12 is discarded after some period of time.

In an alternative example, the evaluation device 12 may search for a corresponding wireless communication chip 15 when the evaluation device 12 detects a specific action. In a case where the evaluation device 12 detects the corresponding wireless communication chip 15, the evaluation device 12 may receive the ID of the evaluation object 11 from the wireless communication chip 15. Then, upon receiving the ID, the evaluation device 12 transmits the received ID to the server 13.

It is preferable for the evaluation device 12 to store the ID transmitted to the server 13. Thereby, in a case where the evaluator carrying the evaluation device 12 wishes to operate the browser client 14, the evaluator can input the stored ID corresponding to the evaluation object 11 to the browser client 14 and confirm the evaluation number of the evaluation object 11 corresponding to the input ID.

The evaluation device 12 executes the below-described program (application) 114 to perform various processes including one or more feature processes of the present invention. The program 114 is downloaded from, for example, the server 13 or a file server operated by the server 13.

### (Server)

The evaluation device 12 communicates with the server 13 via a network. The network is, for example, a network including an IP network (i.e. a network that performs communications by using an internet protocol(s)) combined with a mobile phone network, a wireless LAN network, or a WiMAX network. In other words, a gateway of a carrier of a mobile phone network or a WiMAX network is connected to the IP network, and an access point of a wireless LAN is connected to the IP network via a router. The evaluation device 12 connects to a base station of the mobile phone network or the WiMAX network and communicates with the server via the gateway. Alternatively, the evaluation device 12 connects to an access point of the wireless LAN and communicates with the server 13 via the router.

The IP address of the server 13 is registered beforehand in the program 114 to be executed by the evaluation device 12. Further, a global IP address may be assigned to the evaluation device 12 beforehand. Further, a base station or an access point may temporarily assign a local IP address to the evaluation device 12.

The server 13 includes two functions. One function of the server 13 is to count evaluations (hereinafter also referred to as “counting function 21” or “counting function unit 21”). The other function of the server 13 is to provide (transmit) evaluation numbers to the browser client 14 (hereinafter also referred to as “providing function 22” or “providing function unit 22”). The providing function unit 22 may also be simply referred to as a transmission unit. The evaluation number is the number of ID receptions (number of times of receiving an ID) that are counted with respect to each ID or the number of weighted values counted with respect a single ID reception. For example, a single ID reception may be weighted to be counted as two receptions. In another example, single ID reception may be weighted in correspondence with the strength of a detected gesture.

With the providing function (providing function unit) 22, the server 13 provides the evaluation number to the browser client 14. The browser client 14 may be a device having a configuration of a common data processing apparatus. It is, however, to be noted that, the evaluation device 12 may also be used as the browser client 14. The browser client 14 and the server 13 are connected via the network. The browser client 14 connects to the server 13 by way of, for example, a browser, receives the evaluation number from the server 13, and displays the received evaluation number. Further, the browser client 14 may receive the evaluation number by electronic mail from the server 13 and display the received evaluation number. The URL (or IP address) of the server 13 may be already known by the browser client 14 or provided from a DNS (Domain Name Server) to the browser client 14.

In a case where the evaluation device 12 also serves as the browser client 14, the evaluation device 12 can receive the evaluation number in response to the ID transmitted to the server 13. In other words, the program 114 that operates in the evaluation device 12 also provides a communication function.

Thereby, the evaluator or the user that is operating the browser client 14 can confirm what evaluation object 11 is being positively evaluated (rated) or how much an evaluation object 11 that has been evaluated by the evaluator is being evaluated by other evaluators. Further, because a provider or the like of the evaluation object 11 either knows the ID of the evaluation object 11 or is at least capable of obtaining the ID of the evaluation object 11, the provider can confirm the evaluation number of the evaluation object 11 provided by the provider itself by inputting the ID of the evaluation object 11 to the browser client 14.

### (Hardware Configuration)

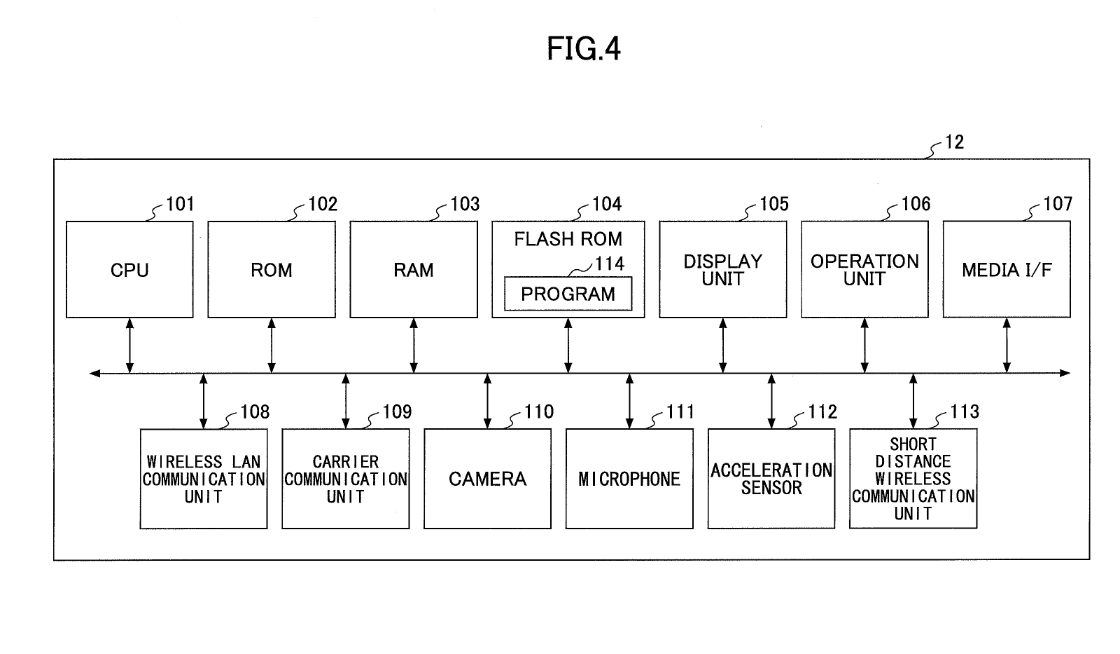

FIG. 4 is a schematic diagram illustrating an example of a hardware configuration of the evaluation device 12 according to an embodiment of the present invention. The evaluation device 12 includes a CPU 101, a ROM (Read Only Memory) 102, a RAM (Random Access Memory) 103, a flash ROM 104, a display unit 105, an operation unit 106, a media I/F (interface) unit 107, a wireless LAN communication unit 108, a carrier communication unit 109, a camera 110, a microphone 111, an acceleration sensor 112, and a short distance wireless communication unit 113.

The CPU 101 controls the entire operations of the evaluation device 12 by executing the program 114 stored in the flash ROM 104. The ROM 102 stores, for example, an IPL (Initial Program Loader) and static data therein. The RAM 103 is used as a work area when the CPU 101 executes the program 114.

The flash ROM 104 stores, for example, an OS (Operating System) executed by the CPU 101 (e.g., Android (registered trademark), iOS (registered trademark), Windows (registered trademark)), middleware, and the program 114 that provides the below-described functions (functional units) of the evaluation device 12 therein. The program 114 may also be referred to as an application.

The display unit 105 may be, for example, a liquid crystal display, an organic electroluminescence display, or a projector. The display unit 105 is for displaying a UI (User Interface). A graphic control unit (not illustrated) interprets the plotting commands written to a video RAM (not illustrated) by the CPU 101 and displays various data including a window, a menu, a cursor, a character, and/or an image on the display unit 105. In this embodiment, the display unit 105 is integrated with a touch panel that displays various soft keys for receiving the user's input/operations.

The operation unit 106 may include, for example, hard keys, a touch panel, or soft keys displayed on the touch panel. The operation unit 106 is for receiving various input/operations from the evaluator (user). The contents of the operations input to the hard keys, the touch panel, and the soft keys are reported to the CPU 101.

The media I/F 107 controls reading or writing (storing) of data with respect to recording media such a flash memory and the like.

The program 114 is recorded to a computer-readable recording medium and distributed in a file format that can be installed or executed by, for example, a computer or the like. Further, the program 114 is also distributed from, for example, the server 13, in a file format that can be installed or executed by the evaluation device 12.

The wireless LAN communication unit 108 performs data reception/transmission by controlling, for example, the modulation method, transmission rate, the frequency based on the IEEE 802.11b/11a/11g/11n standards. In a case of receiving data, the wireless LAN communication unit 108 converts received radio waves into digital signals. In a case of transmitting data, the wireless LAN communication unit 108 performs, for example, modulation on data requested to be transmitted by the CPU 101 according to a predetermined communication standard and transmits the modulated data.

The carrier communication unit 109 performs various types of communications depending on the carrier to which the evaluator of the evaluation device 12 has subscribed. The carrier may be, for example, a carrier for providing mobile phone communications complying with CDMA or LTE communication standards or a carrier for WiMax communications. A SIM (Subscriber Identity Module) card is attached to the carrier communication unit 109. The SIM card is an IC card that stores subscriber data therein. The subscriber data is issued to each subscriber from a corresponding carrier. The subscriber data includes, for example, a unique number referred to as an IMSI (International Mobile Subscriber Identity) and a mobile phone number.

The carrier communication unit 109 performs, for example, modulation based on a communication method determined by a corresponding carrier and communicates with a base station (not illustrated) connected to the Internet. The base station is connected to the server (carrier server) 13 of the corresponding carrier. The carrier server 13 provides a temporary IP address to the evaluation device 12 and transmits an ID to an IP network via a gateway.

The camera 110 is a color imaging unit including a photoelectric conversion element of a CCD (Charge Coupled Device) or a CMOS (Complementary Metal Oxide Semiconductor). In a case where the camera 110 is a stereo camera or a camera having a distance measuring function (e.g., using ultrasonic waves), the camera 110 can determine the distance from the evaluation object 11. Accordingly, the camera 110 can estimate the size of the evaluation object 11 from the focal distance of the lens of the camera 110. Thereby, the evaluation object 11 can easily be identified from the image of the evaluation object 11.

The microphone 111 collects the sounds (e.g., voice) from the evaluator and converts the sounds into electric signals. Further, the program 114 operating in the evaluation device 12 converts the electric signals into text data (i.e. voice recognition).

The acceleration sensor 112 is a sensor that detects acceleration of the evaluation device 12 with respect to an x-axis, a y-axis, and a z-axis. That is, the acceleration sensor 112 detects the orientation of the evaluation device 12 and/or detects the direction in which the evaluation device 12 moves inside a space. In addition to the acceleration sensor 112, the evaluation device 12 may also include a gyro-sensor, a geomagnetic sensor, or a fingerprint sensor. The gyro-sensor detects the angular rate of the evaluation device 12 with respect to an x-axis, a y-axis, and a z-axis. The geomagnetic sensor detects an azimuth based on the direction of the earth's magnetism. By combining the detection results obtained from these sensors, sophisticated specific action can be detected.

The short distance wireless communication unit 113 performs RFID communications with the wireless communication chip 15. In a case where the wireless communication chip 15 is a passive type IC tag, the short distance wireless communication unit 113 performs communications according to the following procedures. First, the short distance wireless communication unit 113 transmits radio waves within a predetermined range. The radio waves include control signals (commands) for controlling the wireless communication chip 15. In a case where the wireless communication chip 15 receives the radio waves, the antenna of the wireless communication chip 15 resonates with the radio waves and generates an electromotive force. The electromotive force activates the circuits in the wireless communication chip 15. Thereby, the wireless communication chip 15 performs various processes (including reading out an ID and transmitting the ID) in accordance with the control signals included in the radio waves. Then, the wireless communication chip 15 modulates a carrier wave of a predetermined frequency with the ID and transmits the modulated wave (including the ID) as a radio wave to the short distance wireless communication unit 113. The short distance wireless communication unit 113 demodulates the radio wave received from the wireless communication chip 15 and extracts the ID from the radio wave.

The short distance wireless communication unit 113 may also communicate by way of Bluetooth (registered trademark) or UWB (Ultra Wide Band). In addition to the aforementioned communication methods, the short distance wireless communication unit 113 may also include a separate RFID communication function.

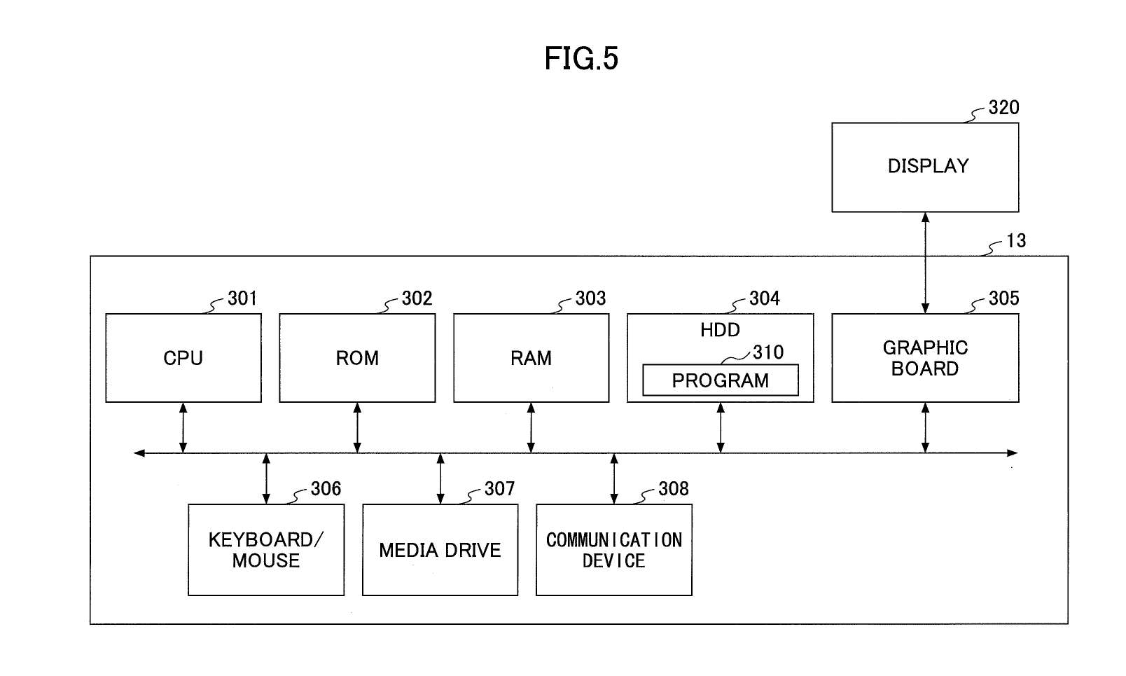

FIG. 5 is a schematic diagram illustrating an example of a hardware configuration of the server 13 according to an embodiment of the present invention. The server 13 may be a device having a configuration of a common data processing apparatus.

The server 13 includes a CPU 301, a ROM 302, a RAM 303, a HDD 304, a graphic board 305 connected to a display 320, a keyboard/mouse 306, a media drive 307, and a communication device 308. The CPU 301 controls the entire operations of the server 13 by executing a program 310 stored in the HDD 304. The CPU 301 uses the RAM 303 as a working memory when executing the program 310. The keyboard/mouse 306 is an input device for receiving inputs and operations from a system administrator. The media drive 307 is for reading and writing data with respect to optical media such as a CD, a DVD, and/or a Bluray (registered trademark) disk. The communication device 308 may be, for example, an Ethernet (registered trademark) for connecting to a network.

The HDD stores, for example, an OS executed by the CPU 301 (e.g., Windows (registered trademark), Linux (registered trademark)), middleware, and the program 310 that provides the below-described functions (functional units) of the server 13 including the counting function 21 and the providing function 22. The program 310 is recorded to a computer-readable recording medium and distributed in a file format that can be installed or executed by, for example, a computer or the like. Further, the program 310 is also distributed from, for example, another server (not illustrated), in a file format that can be installed or executed by the server 13.

In this embodiment, the hardware configuration of the browser client 14 is substantially the same as the hardware configuration of the server 13. However, the browser client 14 may have a hardware configuration that is different from the hardware configuration of the server 13.

### (Functions)

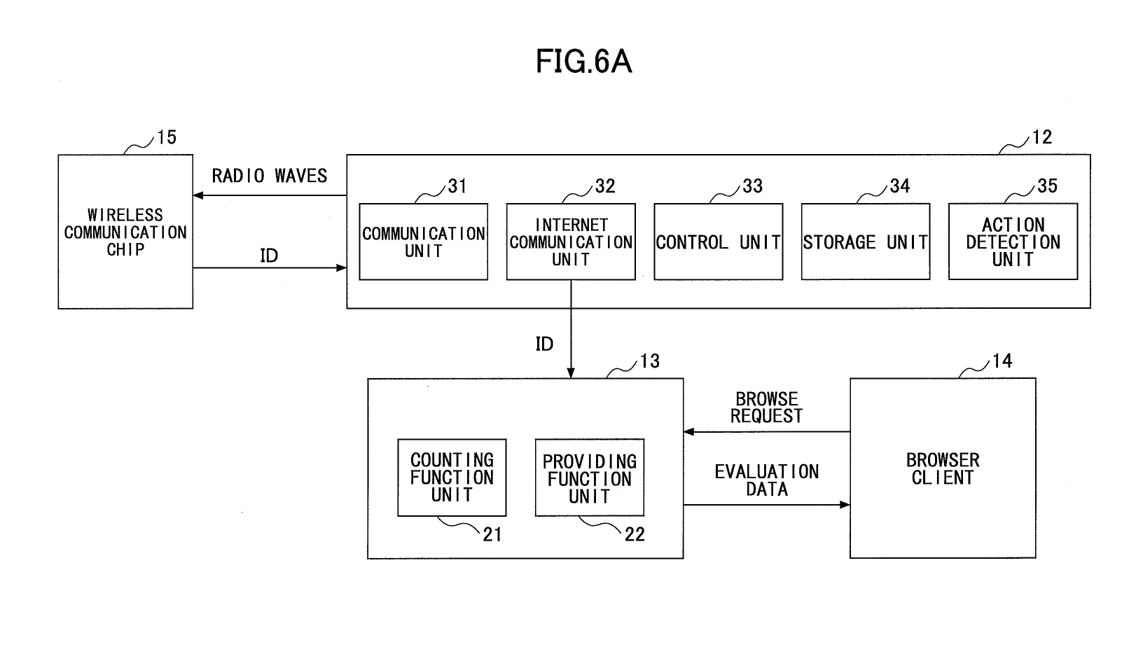

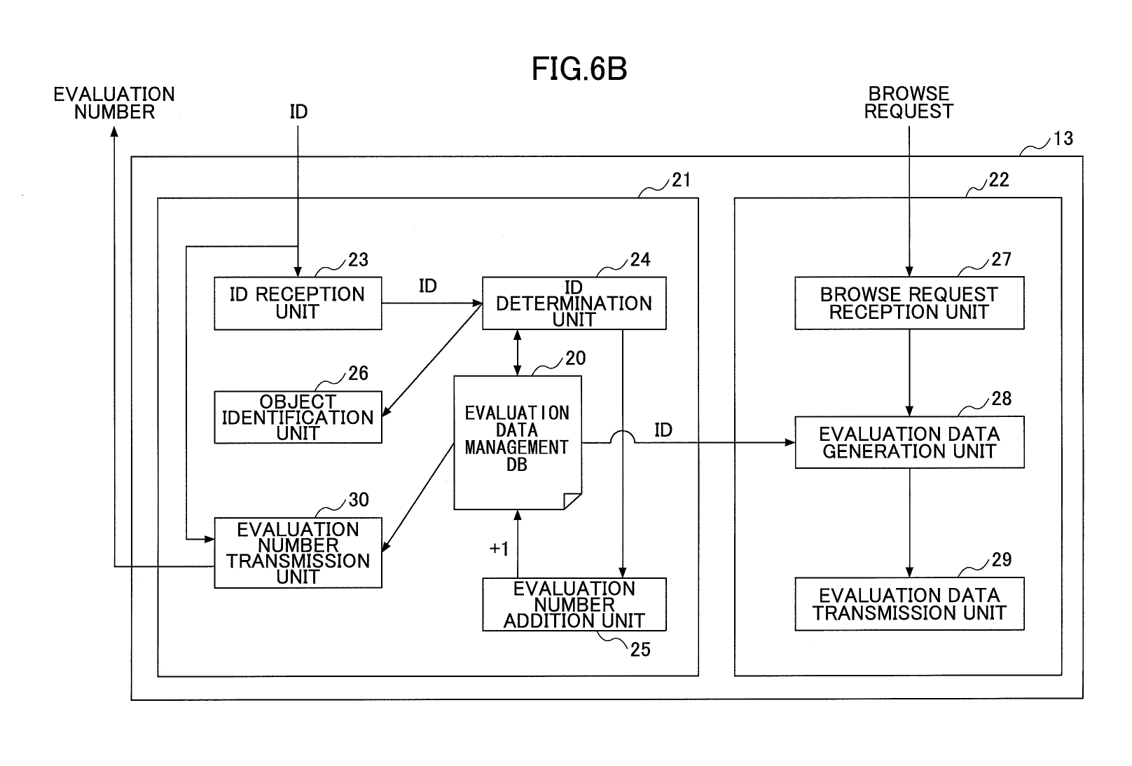

FIGS. 6A-6B are functional block diagrams of the evaluation system 500 including the evaluation device 12 according to an embodiment of the present invention. The evaluation device 12 includes, for example, a communication unit 31, an internet communication unit 32, a control unit 33, a storage unit 34, and an operation detection unit 35. The evaluation device 12 is controlled by the control unit 33. The control unit 33 controls, for example, the communication unit 31 or the internet communication unit 32 according to a predetermined procedure and transmits an ID received from the wireless communication chip 15 to the server 13. It is to be noted that the internet communication unit 32 is configured to receive evaluation numbers.

### (Evaluation Device)

The communication unit 31 controls the short distance wireless communication unit 113 and obtains an ID from the wireless communication chip 15. The internet communication unit 32 controls, for example, the carrier communication unit 108 or the wireless LAN communication unit 108 according to a protocol(s) of the application layer (e.g., FTP, HTTP) and communicates with the server 13, to thereby transmit the ID to the server 13.

Because a plurality of evaluation objects 11 may be within a communicable range of the communication unit 31, the communication unit 31 may obtain multiple IDs from the plurality of evaluation objects in a short period of time. In such a case of receiving multiple IDs in a short period of time, the internet communication unit 32 may control the transmission of IDs to the server 13 as follows.

Transmit all IDs

Transmit only the last single ID

Transmit only the single ID selected by the evaluator

Transmit the single ID having the highest radio wave strength

The case of transmitting all IDs applies to a case where the plurality of evaluation objects 11 can be evaluated in a batch. Transmitting all IDs may be effective in a case of, for example, evaluating a series of evaluation objects 11 (e.g., daily commodities or interior goods that share the same design or aesthetic). The last single ID is an ID that was received last after a predetermined period or more has elapsed beginning from a time when an ID was last received to a time of receiving a next ID (i.e. a case where reception of IDs has ceased). The evaluator is anticipated to move from one place to another but stops when the evaluator finds an evaluation object 11 of interest. Therefore, it is highly possible that the last ID is an ID of the evaluation object 11 that has caused the evaluator to stop (i.e. evaluation object 11 of the evaluator's interest). Accordingly, by transmitting the last ID, the server 13 can obtain the ID of the evaluation object 11 which the evaluator has an interest.

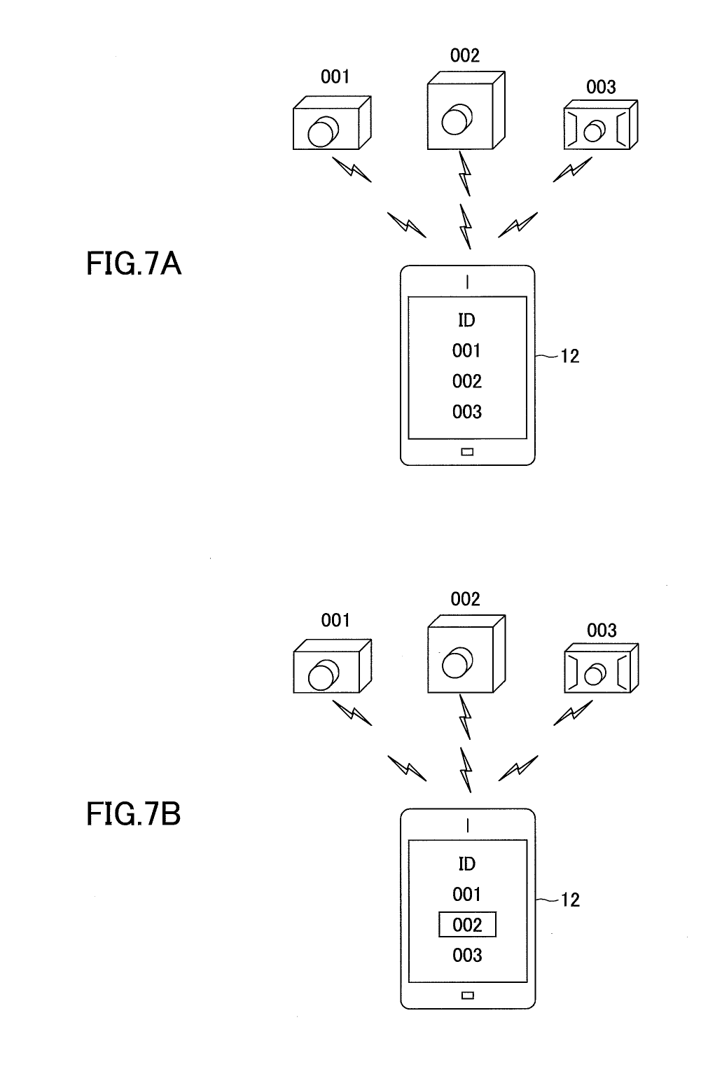

The ID selected by the evaluator is an ID which the evaluator has chosen from a number of IDs. FIG. 7A is a schematic diagram illustrating an example where an ID is displayed on the display unit 105 according to the communication with the communication unit 31. In the example of FIG. 7A, three evaluation objects 11 (in this example, 3 cameras) are located within a communicable range of the communication unit 31. Accordingly, the display unit 105 displays three IDs. In this case, the evaluator identifies (specifies) the ID of the evaluation object 11 evaluated by the evaluator by causing the evaluation device 12 to perform communication again with the evaluation object 11. In a case where the short distance wireless communication unit 113 has directivity, the evaluation object 11 towards which the evaluation device 12 is directed transmits the ID to the evaluation device 12. Thereby, the evaluator can identify the ID of the evaluation object 11. Further, in a case where the wireless communication chip 11 has transmitted data (e.g., product name) to the evaluation device 12, the evaluation device 12 displays the ID together with the product name on the display unit 105. Thereby, the evaluator can easily select the ID.

Further, the ID having the highest radio wave strength is an ID of the evaluation object 11 that is located nearest to the evaluation device 12. FIG. 7B is a schematic diagram illustrating an example where an ID is selected according to radio wave strength. Because the communication unit 31 can identify the ID of the wireless communication chip 15 having the highest radio wave strength, the evaluation device 12 can display the ID surrounded by a rectangular frame or display the ID in reverse order. In a case where the evaluator has found an evaluation object 11 of interest, it is anticipated that the evaluation object 11 is located near the evaluation device 12. Thereby, the evaluator can transmit the ID of the evaluation object 11 of interest.

Instead of making the evaluator select the ID and transmit the ID, the internet communication unit 32 may transmit the ID of the wireless communication chip 15 having the highest radio wave to the server 13.

In some cases, it may be preferable for the internet communication unit 32 to transmit other data together with the ID. For example, there may be a case where the server 13 cannot identify the evaluation object 11 only by referring to the ID of the evaluation object 11 (e.g., a case where an ID is not stored in the server 13 or a case where evaluation objects 11 having the same IDs are stored in the server 13). Therefore, the internet communication unit 32 may transmit data related to the evaluation object (related data) together with the ID.

The related data may be, for example, a unique number of the evaluation device 12, position data of the evaluation device 12, time data, the direction in which the evaluator is moving (movement direction), an image of the evaluation object 11, a comment input to the evaluation device 12 by the evaluator regarding the evaluation object 11, or data received from the wireless communication chip 15. The data received from the wireless communication chip 15 may be any kind of data for facilitating the management of evaluation objects 11 by the server 13. The unique number of the evaluation device 12 may be, for example, IMSI (International Mobile Subscriber Identity) or a telephone number of the evaluation device 12 (e.g., a phone number of a mobile phone). The position data of the evaluation device 12 may be detected from a GNSS (Global Navigation Satellite System) installed in the evaluation device 12. Alternatively, the position data of the evaluation device 12 may be calculated from the radio wave strength obtained from multiple base stations and the positions of the base stations. The movement direction may be data indicating north/south/east/west. The movement direction may be identified, for example, by position data obtained in time series or values detected from the geomagnetic sensor. The image of the evaluation object 11 may be an image captured by the camera 110. The comment input to the evaluation device 12 by the evaluator may be, for example, the name of the evaluation object 11 or detailed contents of the evaluation (ratings) by the evaluator.

In a case where the evaluation system 500 is held in an area of a specific range (e.g., inside a department store or an exhibition hall), it may be effective to include personal data (on condition that the transmission of the personal data is permitted by the evaluator) in the related data. For example, the personal data mainly includes contact data of the evaluator such as, a company name of the evaluator, a full name of the evaluator, an address of the evaluator, a telephone number of the evaluator, or an e-mail address of the evaluator. In a case where the evaluator is interested in an evaluation object 11, the evaluator would often desire to obtain detailed information on the evaluation object 11. Further, the provider of the evaluation object 11 (product or service) would often desire to contact the evaluator. This is quite common in a venue such as an exhibition hall.

The storage unit 34 stores the IDs received by the communication unit 31. Preferably, the storage unit 34 also stores the data of the time and position of receiving the IDs. Further, in a case where the evaluator has obtained an image of the evaluation object 11 with the camera 110, the storage unit 34 stores data of the image of the evaluation object 11.

In a case where the action detection unit 35 determines that a specific action has been performed based on the acceleration detected by the acceleration sensor 112, the action detection unit 35 notifies detection of the specific action. The specific action detected by the acceleration sensor 112 may be, for example, a “gesture action”. The specific action detected by the action detection unit 35 may be, for example, vertically shaking the evaluation device 12. In a case where the evaluator performs the vertically shaking action, the action detection unit 35 detects successive changes of acceleration (e.g., successive changes of acceleration between a downward direction and an upward direction). Alternatively, the action that is set as the specific action may be to vertically shake the evaluation device 12 a predetermined number of times, horizontally shake the evaluation device 12 a predetermined number of times, or to thrust the evaluation device 12 forward. Accordingly, the acceleration sensor 112 detects changes of acceleration according to the specific action. Typical changes of acceleration of each action may be stored in the action detection unit 35 beforehand. Thereby, the action detection unit 35 can detect the specific action of the evaluator by comparing the stored data with detected changes of acceleration.

The specific action is not limited to the gesture action but may also be audio input (voice input) or a specific operation (maneuver) performed on a touch panel, a hard key or a soft key of the display unit 105 of the evaluation device 12.

Alternatively, the specific action may be taking a picture with the camera 110. Alternatively, the specific action may be a combination of actions (e.g., combining the gesture action with voice input or a specific operation on the evaluation device 12). Thereby, a combination of specific actions may be set as a condition for transmitting the ID from the evaluation device 12.

### (Server)

The counting function unit 21 of the server 13 includes an ID reception unit 23, an evaluation number addition unit 25, an ID determination unit 24, an object identification unit 26, an evaluation number transmission unit 30, and an evaluation data management DB 20. Alternatively, the evaluation data management DB 20 may be excluded from the server 20 if the server 13 can access the evaluation data management DB 20.

The ID reception unit 23 receives an ID and related data (if any) from the evaluation device 12. The ID determination unit 24 identifies the evaluation object 11 based on the ID. As described, there is a case where the evaluation object 11 can be identified by referring the ID (former case) and a case where the evaluation object 11 cannot be identified by the ID (latter case). The former case may be a case where IDs are only assigned to evaluation objects 11 that are already stored (registered) in the server 13. In this former case, the ID determination unit 24 can uniquely identify the evaluation object 11 from the ID. The former case applies to a case where the evaluation system 500 is used in an area of a specific range (e.g., exhibition hall, or department store). In contrast, in a case where various providers of the evaluation objects 11 arbitrarily assign IDs to the evaluation objects without regard to the server 13, it is difficult to identify the evaluation objects 11 by IDs. In other words, the latter case applies to a case where IDs are not stored in the server 13 or a case where IDs are redundantly stored in the server (overlapping IDs).

In a case where there is an ID that matches an ID that is already stored in the evaluation data management DB 20, the ID determination unit 24 sends the ID to the evaluation number addition unit 25. In a case where there is a possibility of being unable to identify the evaluation object 11 of the ID due to the existence of an overlapping ID, the ID determination unit 24 narrows down the overlapping IDs based on related data. Then, the narrowed down ID is sent to the evaluation number addition unit 25.

In a case where no matching ID is found in the evaluation data management DB, the ID is newly stored (registered) in the evaluation data management DB and sent to the evaluation number addition unit 25. The evaluation number of the newly stored ID is zero.

In a case where an ID is received from the same evaluation device 12 by referring to the unique number included in the related data, the ID determination unit 24 may discard the ID. By discarding the ID, an evaluation object 11 can be prevented from being repeatedly evaluated (rated) by the same evaluator.

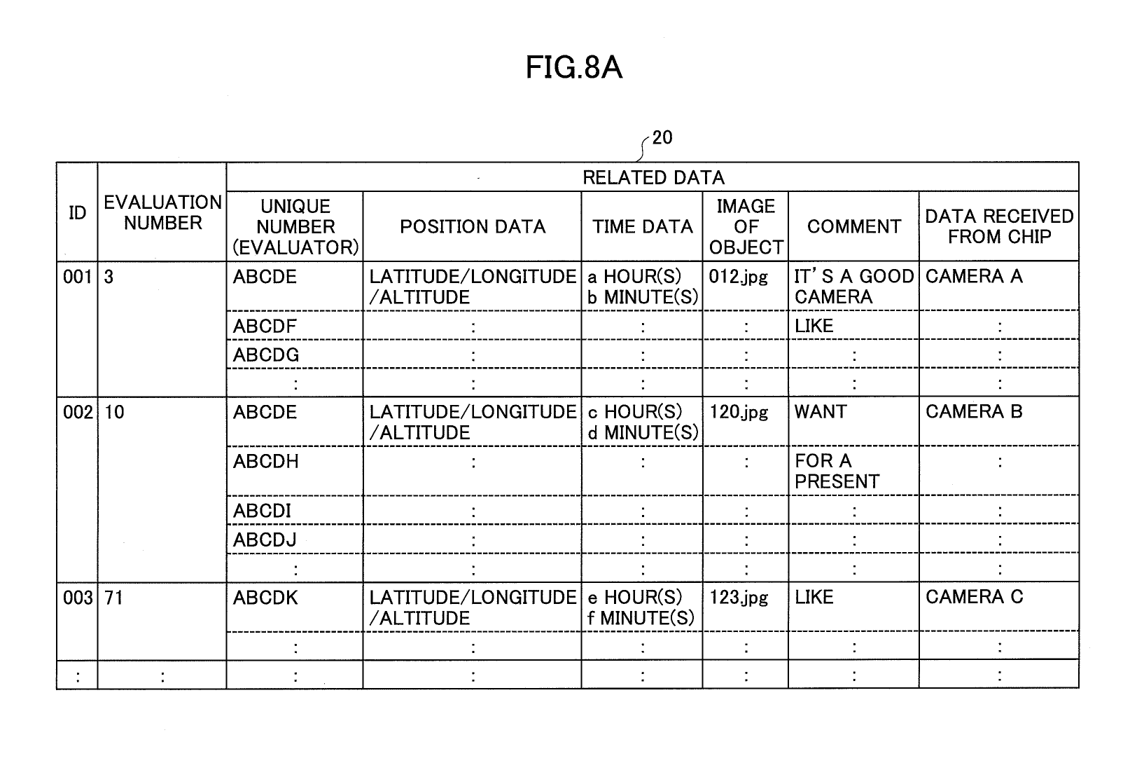

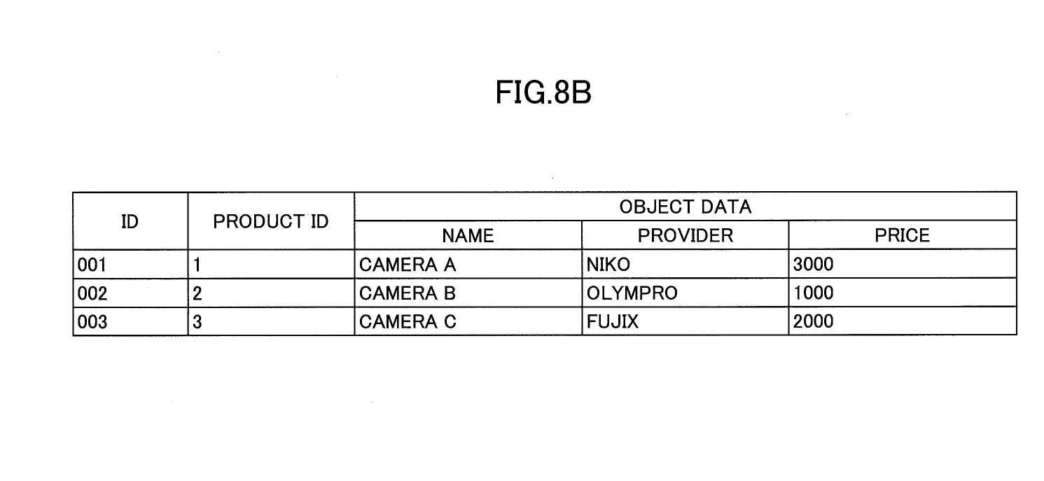

FIG. 8A illustrates an example of an evaluation result table stored in the evaluation data management DB 20 according to an embodiment of the present invention. In the example of FIG. 8A, “ID” is associated to “evaluation number” and “related data”. In this embodiment, the evaluation number addition unit 25, as a rule, increments the evaluation number one at a time (+1). As described above, the related data includes data such as unique number, position data, image of evaluation object 11, comments, and data received from the wireless communication chip 15.

The evaluation number in the table of FIG. 8A indicates the evaluation number in a case where a transmission of an ID is counted as a positive evaluation (positive rating). In a case where a negative evaluation (negative rating) is also counted, two kinds of evaluation numbers may be indicated in the table (e.g., “evaluation number (positive)” and “evaluation number (negative)”.

It is preferable for the server 13 to be able to identify the evaluation object 11 that has been evaluated. Therefore, the server 13 includes an object identifying table.

FIG. 8B illustrates an example of the object identifying table stored in the evaluation data management DB 20 according to an embodiment of the present invention. In the example of FIG. 8B, “ID” is associated to “product ID” and “object data”. In a case where the evaluation system 500 is used in an area of a specific range (e.g., exhibition hall, department store), the relationship between the ID and the evaluation object 11 (e.g., product, service) can be identified. Therefore, not only can the ID of the evaluation object 11 be obtained but also data pertaining to, for example, “product ID”, “name”, “price” etc. can be obtained. The “product ID” is identification data used for enabling products to be identified by a provider. Because the product ID is managed by the provider, the products ID need only be unique to the provider. The “name” indicates, for example, the name of a product or a service. In a case where the product is a camera, the “name” may be, for example, camera A, camera B, and camera C. In a case where the service is catering, the “name” may be a name of a brand of a restaurant. The “provider” indicates, for example, a manufacturer or a seller of the evaluation object 11. Although the “price” indicates the price of the evaluation object 11, the price of the evaluation object 11 is not a requisite. Further, a common name of the product or service corresponding to the evaluation object 11 may also be stored in the object identifying table. Thereby, the user of the browser client 14 can browse a desired evaluation number by designating, for example, the ID of the evaluation object 11, the name of the evaluation object 11, or the provider of the evaluation object 11.

In the case where IDs are arbitrarily assigned to the evaluation objects 11 without regard to the server 11, it is difficult to identify the evaluation objects 11 by the IDs. Therefore, it is preferable for the server 13 to continuously build data pertaining to the evaluation objects 11 based on the related data.

In a case where the ID determination unit 24 determines that none of the IDs stored in the evaluation data management DB 20 corresponds to an ID of an evaluation object 11, the object identification unit 26 of the server 13 attempts to identify the evaluation object 11 by using the data stored in the evaluation data management DB 20 such as related data. For example, the object identification unit 26 identifies a name or a provider by extracting a noun by performing a parsing process (syntax analysis) on the comments included in the related data and searching for the noun in a dictionary or a search engine.

In a case where the action detection unit 35 detects a specific action, the program 114 may display a space (column) for inputting data of the evaluation object 11 on the display unit 105. Thus, when the evaluator has explicitly input the data of the evaluation object 11 (e.g., name, provider, price) and transmitted the input data to the server 13, the object identification unit 26 can use the transmitted data and securely store the data of the evaluation object 11.

In a case where data such as “name”, “provider”, and “price” are stored in the wireless communication chip 15, the wireless communication chip 15 can transmit the stored data together with the ID to the evaluation device 12. Thereby, the object identification unit 26 can identify the evaluation object 11 based on the data transmitted from the wireless communication chip 15.

Further, the object identification unit 26 can identify the name or the provider of the evaluation object 11 by identifying map data of a store located at a position indicated in the position data of the related data. The data of a name of a shop (provider) is often included in the map data. Further, the name of the products or services provided can be searched by referring to the name of the shop. Therefore, the name or the provider of the evaluation object 11 can be identified by inputting the position data or an address to a search engine.

Further, the object identification unit 26 can also identify the evaluation object 11 from an image 11. An image that matches an image of the evaluation object 11 can be identified by searching a database or the Internet by using an image matching method of the below-described second embodiment. Based on a description of the identified image, data such as the product name or the seller can be extracted. Thereby, data of the evaluation object 11 such as the provider and the price can be identified. Accordingly, the object identification unit 26 stores the identified data of the evaluation object 11 in the target identification table.

Returning to FIG. 6B, the evaluation number addition unit 25 increments (i.e. updates) the evaluation number associated with the ID in the evaluation result table when the evaluation number addition unit 25 receives the ID from the ID determination unit 24. Thereby, a positive evaluation (positive rating) is given to the evaluation object 11 corresponding to the ID that has been transmitted many times.

The evaluation number transmission unit 30 reads out the evaluation number updated by the evaluation number addition unit 25 from the evaluation result table based on the ID transmitted from the evaluation device 12. In addition to transmitting the updated evaluation number, the evaluation number transmission unit 30 may also transmit data stored in the evaluation data management DB 20 (e.g., product name) to the evaluation device 12.

The providing function part 22 of the server 22 includes a browse request reception unit 27, an evaluation data generation unit 28, and an evaluation data transmission unit 29. The browse request reception unit 27 receives a request to browse the evaluation number (browse request) from the browser client 14. When the browser client 14 accesses the server 13 by way of, for example, a browser, the browse request reception unit 27 transmits HTML data of a top page to the browser client 14.

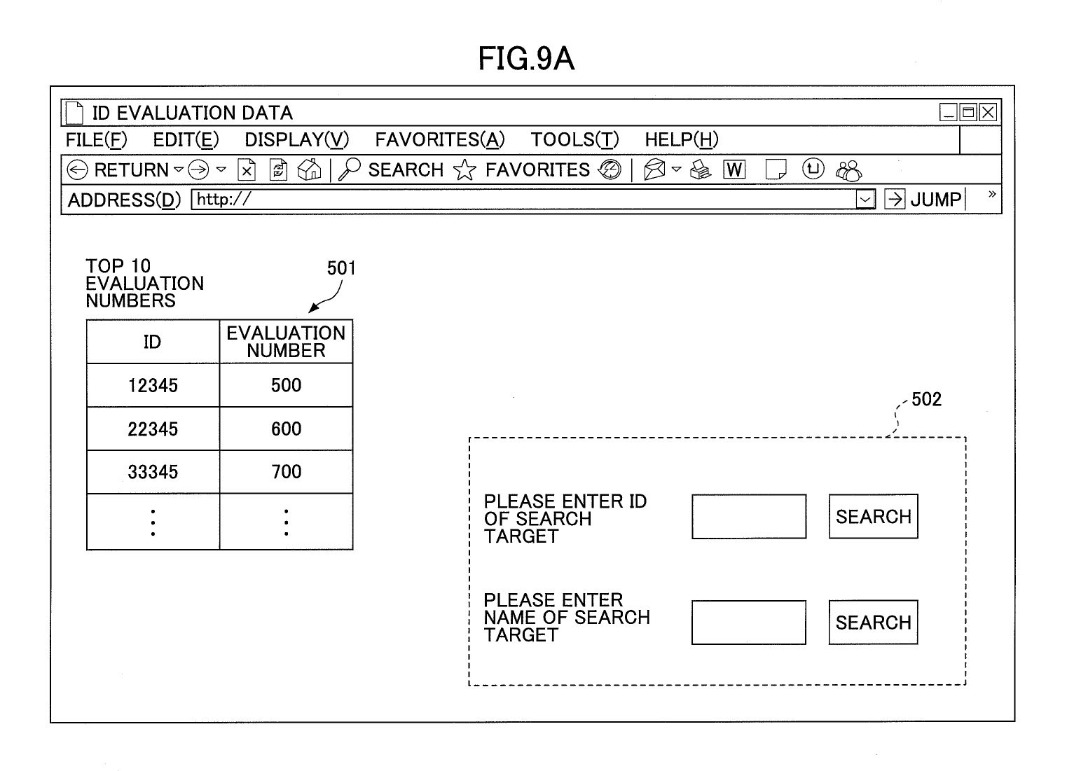

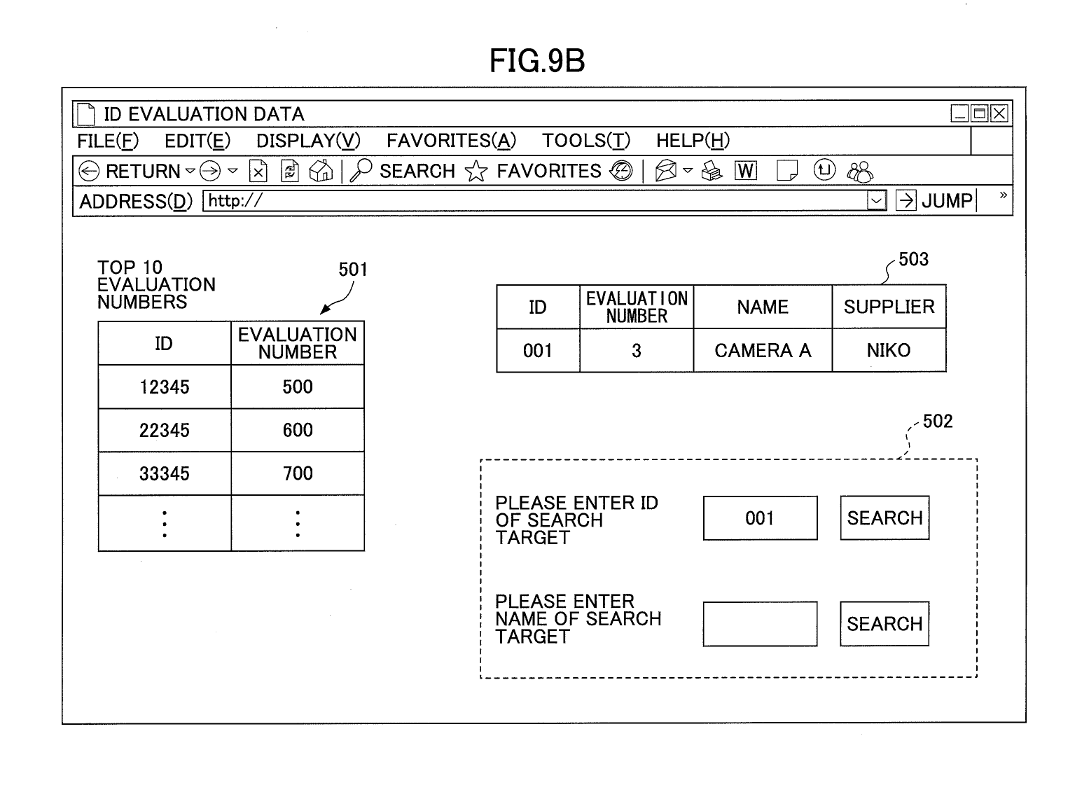

FIG. 9A is a schematic diagram illustrating a top page displayed on the browser client 14 according to an embodiment of the present invention. The top page includes a top rank display area 501 and a search area 502. The top 10 IDs having the most evaluation numbers and the evaluation numbers of the top 10 IDs are displayed in the top rank display area 501. In addition, the product names corresponding to the IDs may also be displayed in the top rank display area 501. The search area 502 is for enabling the evaluation number of the evaluation object 11 to be searched based on an ID of the evaluation object 11 or the name of the evaluation object 11. In a case of searching the evaluation object 11 based on the ID of the evaluation object 11, a message “please enter ID of search target” is displayed in the search area 502. In a case of searching the evaluation object 11 based on the name of the evaluation object 11, a message “please enter name of search target” is displayed in the search area 502. In addition to inputting the ID or the name of the evaluation object 11, the product ID or the provider may be input in the search area 502. In a case where the operator of the browser client 14 already knows the product ID of the evaluation object 11, the operator of the browser client 14 can obtain the evaluation number of the evaluation object 11 by using the product ID of the evaluation object 11. Accordingly, the operator of the browser client 14 can search for the evaluation number of the evaluation object 11 by using a desired method (e.g., searching by ID or name of the evaluation object 11).

When the browse request reception unit 27 receives the ID or the name of the evaluation object 11 from the browser client 14, the evaluation data generation unit 28 generates evaluation data. In a case of receiving the ID of the evaluation object 11, the browse request reception unit 27 searches for a corresponding ID from the evaluation result table and reads out an evaluation number of a record (row) having a matching ID. In a case where other data pertaining to the evaluation object 11 (object data) is also stored in the evaluation result table, the object data may also be read out from the evaluation result table. The evaluation data generation unit 28 generates evaluation data including at least the ID of the evaluation object 11 and the evaluation number of the evaluation object 11. The evaluation data may also include the object data. The evaluation data is generated by using, for example, HTML. The evaluation data transmission unit 29 transmits the evaluation data to the browser client 14. In a case where the browse request reception unit 27 receives a product ID from the browser client 14, the evaluation data generation unit 28 performs the process of generating evaluation data after converting the product ID to the ID of the evaluation object 11.

In a case where the browse request reception unit 27 receives a name of the evaluation object 11, the evaluation data generation unit 28 searches and obtains an ID having a name that matches the received name (in a case where there are multiple matches, all IDs are read out). Then, the evaluation data generation unit 28 reads out the evaluation number corresponding to the obtained ID. The evaluation data generation unit 28 generates evaluation data including at least the ID of the evaluation object 11 and the evaluation number of the evaluation object 11. The evaluation data may also include the object data. The evaluation data is generated by using, for example, HTML.

Thereby, the browser client 14 displays the evaluation data as illustrated in FIG. 9B. In FIG. 9B, a search result area 503 is newly displayed in the top page. The ID, the evaluation number, and the supplier (provider) of the evaluation object 11 are displayed in the search result area 503. Thereby, the browser client 14 can display the evaluation number of the evaluation object 11. Although not illustrated in the drawings, other data managed by the server 13 may also be displayed in the browser client 14. For example, the browser client 14 may also display, for example, comments of the evaluator, the image of the evaluation object 11, and the location (position data) of the evaluation object 11.

Further, the evaluation data generation unit 28 may process the evaluation data to be generated (e.g., evaluation number). For example, the evaluation data generation unit 28 may refer to the time data and count, for example, only the evaluation numbers received during the last past 1 hour. Alternatively, the evaluation data generation unit 28 may refer to the position data and count, for example, the evaluation number in correspondence with various areas. Alternatively, the evaluation data generation unit 28 may refer to the unique number of the evaluation object 11 and count, for example, the evaluation number in correspondence with each evaluator.

The operator (administrator) of the evaluation system 500 provides the IDs, the evaluation numbers, the related data, the product IDs, and the object data with or without charge (i.e. charge or free of charge). For example, in a case of using the evaluation system 500 in an exhibition hall or a department store, the operator of the evaluation system 500 provides IDs and evaluation numbers to the exhibitor of the exhibition hall or the shops in the department store. Further, it is also preferable to provide the related data and individual data. Thereby, the exhibitor of the exhibition hall or the shops in the department store can know the evaluation object 11 that is being positively evaluated (highly rated) based on the IDs. Accordingly, the exhibitor of the exhibition hall or the shop in the department store can contact the evaluator interested in the evaluation object 11.

Further, the evaluation system 500 may be applied to a SNS (Social Networking Service) or a Web site. In a case where the evaluation system 500 is applied to the SNS or the Web site, the SNS or the Web site can provide data pertaining to an evaluation object 11 that is highly rated in the reality space to a browser of the Web site. As a result, the number of visitors to the SNS or the Web site can increase. Thereby, an increase in advertisement revenue can be anticipated.

### (Operation Procedure)

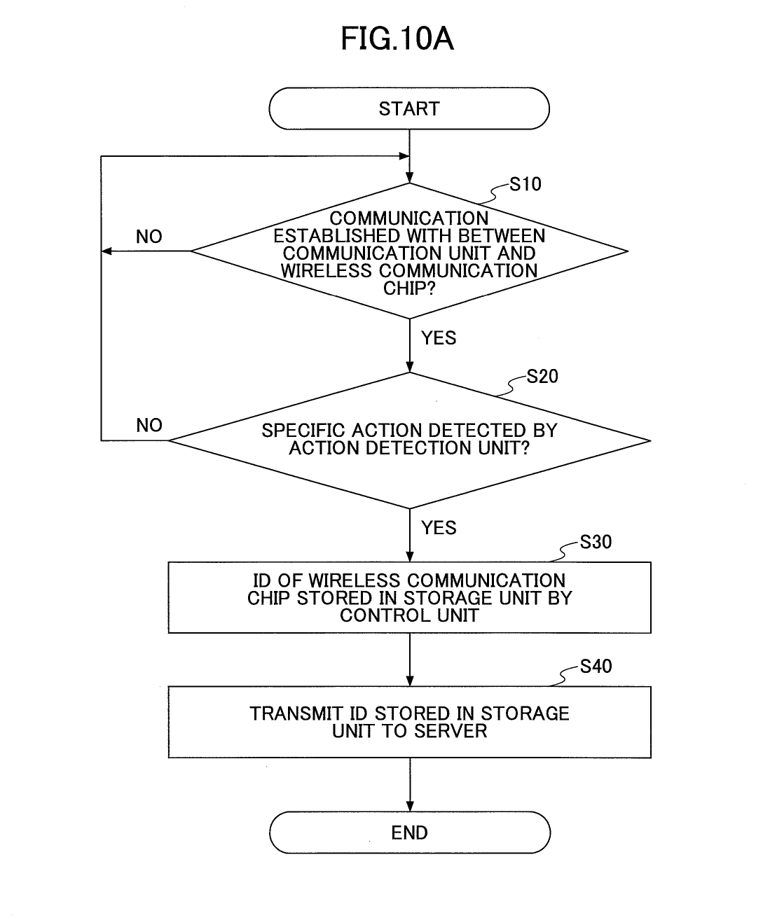

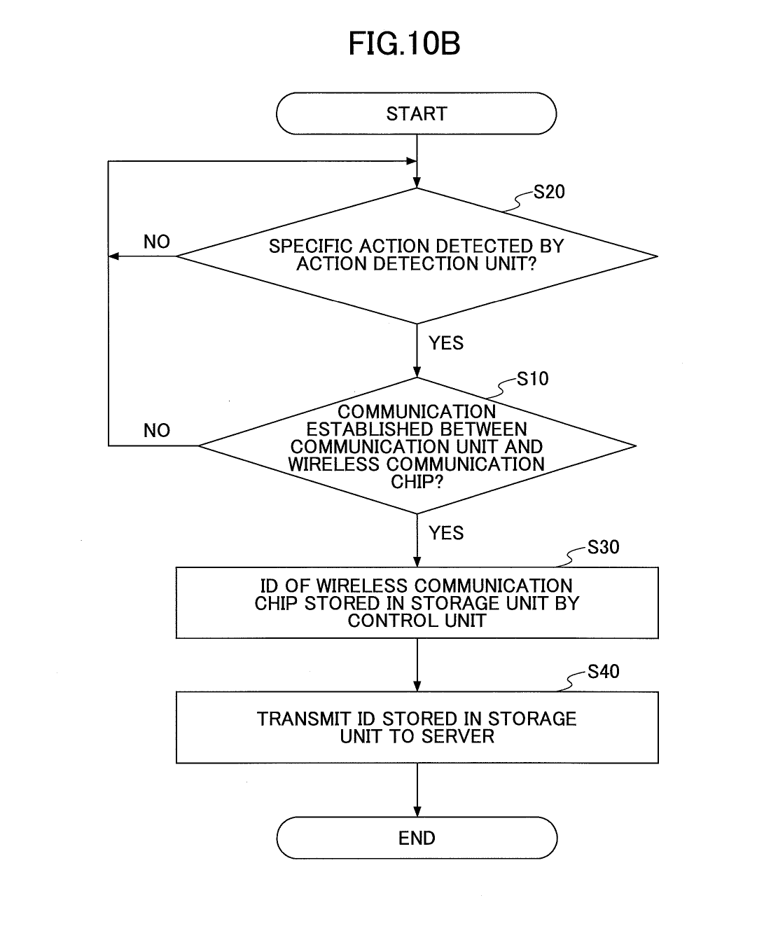

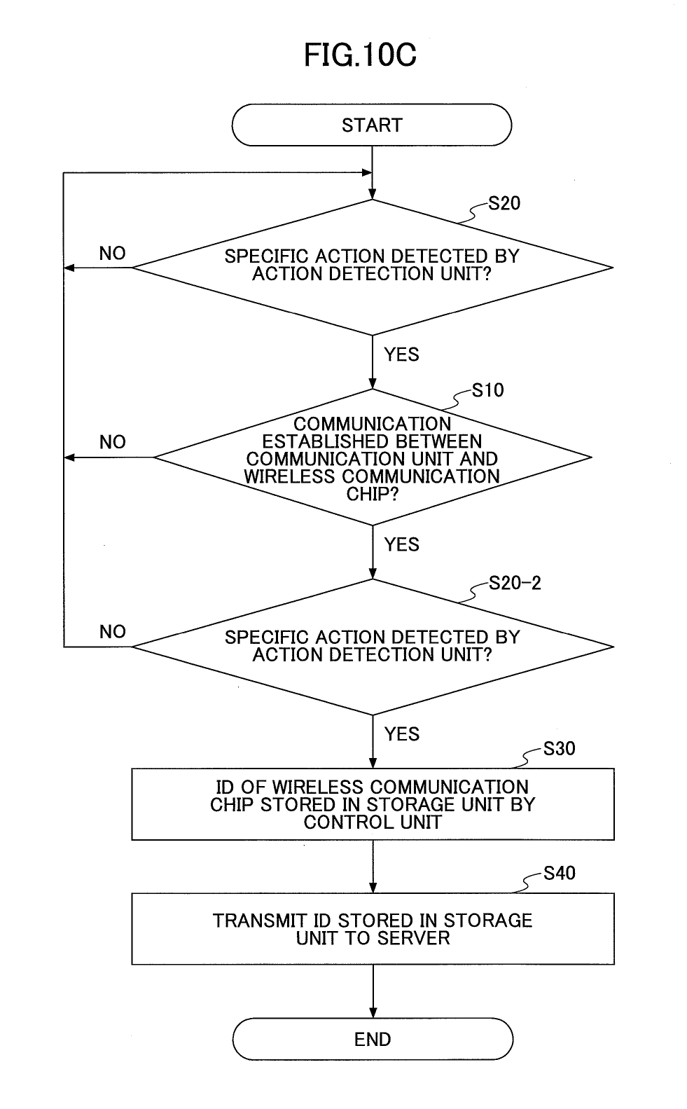

FIGS. 10A-10C describe three examples of communication procedures performed in the evaluation system 500 according to an embodiment of the present invention. Any one or more of the three communication procedures may be used. Further, communication procedures other than those illustrated in FIGS. 10A-10C may also be used.

FIG. 10A is a flowchart illustrating a procedure of evaluating the evaluation object 11 with the evaluation device 12 according to an embodiment of the present invention. The procedure of FIG. 10A is repeatedly executed during a period where the program 114 is being executed by the evaluation device 12.

The communication unit 31 establishes communication with the wireless communication chip 15 (Step S10). The establishing of communication includes, for example, a state where the wireless communication chip 15 and the communication unit 31 can communicate with each other or a state where the wireless communication chip 15 and the communication unit 31 can exchange identification data and communication with each other. The communication procedure may be performed in compliance with, for example, an RFID standard. Alternatively, the communication unit 31 may determine that communication is established when the communication unit 31 receives an ID from the wireless communication chip 15. The communication unit 31 periodically searches for the wireless communication chip 15 and receives an ID when the wireless communication chip 15 is located within a communicable range of the communication unit 31. Once the communication unit 31 receives the ID from the wireless communication chip 15, the communication unit 31 may continue to maintain the communication established between the communication unit 31 and the wireless communication chip 15 or cease to maintain the communication established between the communication unit 31 and the wireless communication chip 15. Further, the communication unit 31 and the wireless communication chip 15 may repeatedly exchange a given type of data, in order to confirm whether the communication opponent (i.e. the communication unit 31 or the wireless communication chip 15) still exists.

In a case where communication is established, it is preferable for the evaluation device 12 to notify reception of the ID from the wireless communication chip 15 by generating a sound (e.g., music) and/or vibration or by displaying a message and/or an icon on the display unit 105. By receiving the ID of the evaluation object 11 by way of the wireless communication chip 15, the evaluator can recognize that the evaluation object 11 can be evaluated.

In a case where communication is established between the wireless communication chip 15 and the communication unit 31 (Yes in Step S10), the control unit 33 determines whether a specific action has been detected by the action detection unit 35 (Step S20). The process of detecting the specific action is described in detail below.

In a case where the specific action is detected by the action detection unit 35 (Yes in Step S20), the control unit 33 stores the ID of the wireless communication chip 15 in the storage unit 34 (Step S30). As described above, it is preferable to store the ID together with corresponding related data.

As described above, in a case where the communication unit 31 establishes communications with a plurality of wireless communication chips 15, the evaluator or the evaluation device 12 may select and store an ID or store all IDs.

The control unit 33 instructs the internet communication unit 32 to transmit the ID stored in the storage unit 34 to the server 13 (Step S40). In a case where communication is difficult due to, for example, a poor radio wave state, the internet communication unit 32 transmits the ID stored in the storage unit 34 when the radio wave state improves (e.g., when the evaluation device 12 has moved to an area with a better radio wave state). Thereby, the ID is transmitted to the server 13.

Next, the procedure illustrated in FIG. 10B is described. Unlike the procedure of FIG. 10A, the procedure of FIG. 10B is a case where a specific action is detected by the action detection unit 35 before communication between the communication unit 31 and the wireless communication chip 15 is established.

In a case where the action detection unit 35 detects a specific action (Yes in Step S20), the control unit 33 instructs the communication unit 31 to establish communication with the wireless communication chip 15.

Then, in a case where the communication unit 31 establishes communication with the wireless communication chip 15 (Yes in Step S10), the control unit 30 stores the ID of the wireless communication chip 15 in the storage unit 34 (Step S30). In this case also, it is preferable for the evaluation device 12 to notify reception of the ID from the wireless communication chip 15 by generating a sound (e.g., music) and/or vibration or by displaying a message and/or an icon on the display unit 105.

Then, the control unit 33 instructs the internet communication unit 32 to transmit the ID stored in the storage unit 34 to the server 13 (Step S40).

In the procedure illustrated in FIG. 10B, the communication unit 31 does not need to constantly search for the wireless communication chip 15. Therefore, power consumption of the evaluation device 12 can be reduced. Further, because the detection of the specific action and the reception of the ID are performed in series, it is easy for the evaluator of the evaluation object 11 to recognize the reception of the ID from the evaluation object 11.

Next, as illustrated in FIG. 100, a plurality of specific movements may be detected until an ID is transmitted.

In a case where the action detection unit 35 detects the first specific action (Yes in Step S20), the control unit 33 instructs the communication unit 31 to establish communication with the wireless communication chip 15. The first specific action detected by the action detection unit 35 may be, for example, a gesture action.

In a case where the communication unit 31 establishes communication with the wireless communication chip 15 (Yes in Step S10), the action detection unit 35 determines whether a second specific action has been detected (Step S20-2). The second specific action may be, for example, a touch panel operation (i.e. an operation performed on a touch panel). In a case where the second specific action is detected, the control unit 33 stores the ID of the wireless communication chip 15 in the storage unit 34 (Step S30). In this case also, it is preferable for the evaluation device 12 to notify reception of the ID from the wireless communication chip 15 by generating a sound (e.g., music) and/or vibration or by displaying a message and/or an icon on the display unit 105.

Then, the control unit 33 instructs the internet communication unit 32 to transmit the ID and the evaluator identification data ID stored in the storage unit 34 (Step S40).

In the procedure illustrated in FIG. 10C, the evaluation device 12 can receive an ID in response to the detection of the first specific action and transmit the ID in response to the detection of the second specific action. Thereby, the evaluator can, first, confirm the ID of the evaluation object 11 and then transmit the ID to the server 13 after confirming the ID. Alternatively, a single ID may be selected and transmitted to the server 13 in a case where the communication unit 31 receives a plurality IDs of a plurality of wireless communication chips 15.

### (Detection of Specific Action (S20))

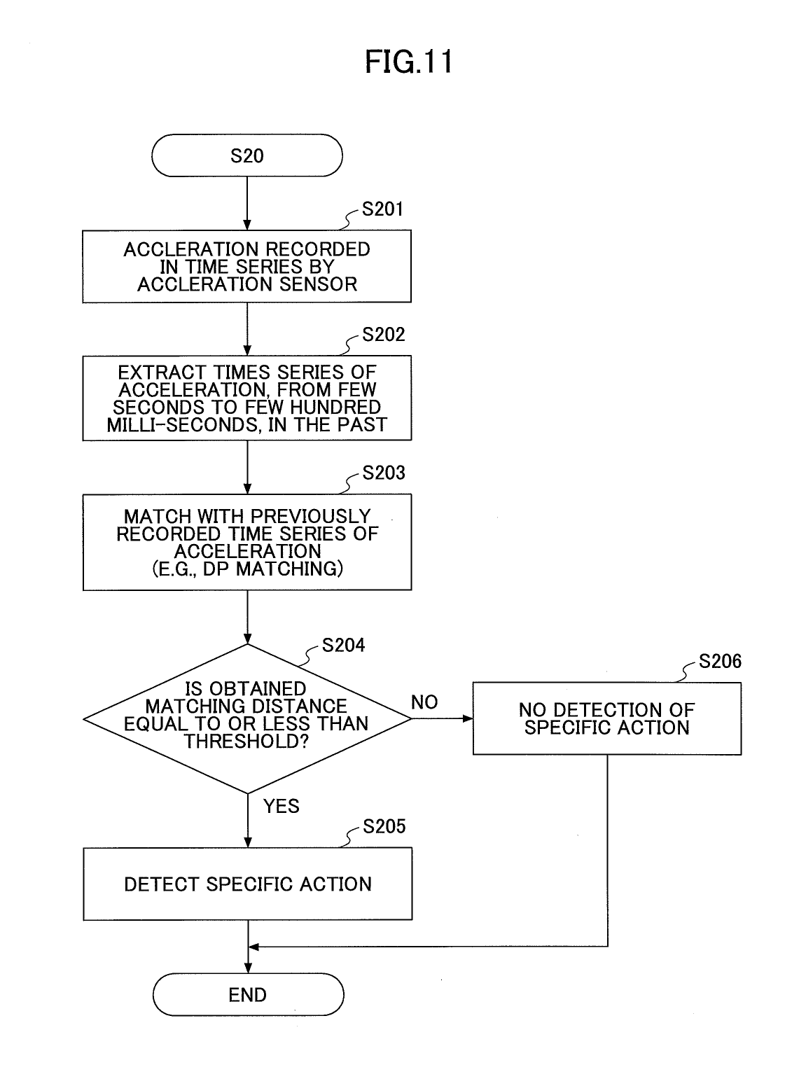

Next, a process of detecting a specific action with the action detection unit 35 is described in a case where the specific action is a gesture action. FIG. 11 is a flowchart illustrating a process of detecting a gesture action with the action detection unit 35 according to an embodiment of the present invention.

First, the acceleration sensor 112 records acceleration of the evaluation device 12 in time series (Step S201).

Then, the action detection unit 35 extracts a time series of accelerations obtained in the past (e.g., a time series from a few seconds ago to a few milliseconds ago).

The action detection unit 35 compares (matches) a typical time series of accelerations stored in the storage unit 34 beforehand with respect to a time series of accelerations detected by the acceleration sensor 112 (Step S203). In this embodiment, DP (Dynamic Programming) matching method is used for the comparison. With the DP matching method, the difference between the typical time series of accelerations and the detected time series of accelerations is calculated (assumed) as a distance.

The action detection unit 35 determines whether the calculated distance is within a threshold (Step S204). In a case where the calculated distance is within the threshold (Yes in Step S204), the action detection unit 35 detects the specific action (Step S205). In a case where the calculated distance is not within the threshold (No in Step S204), the action detection unit 35 does not detect the specific action (Step S206).

The above-described determination using DP matching is merely an example of detecting the specific action. Other pattern recognition methods may also be used for detecting the specific action.

### (Operation of Server)

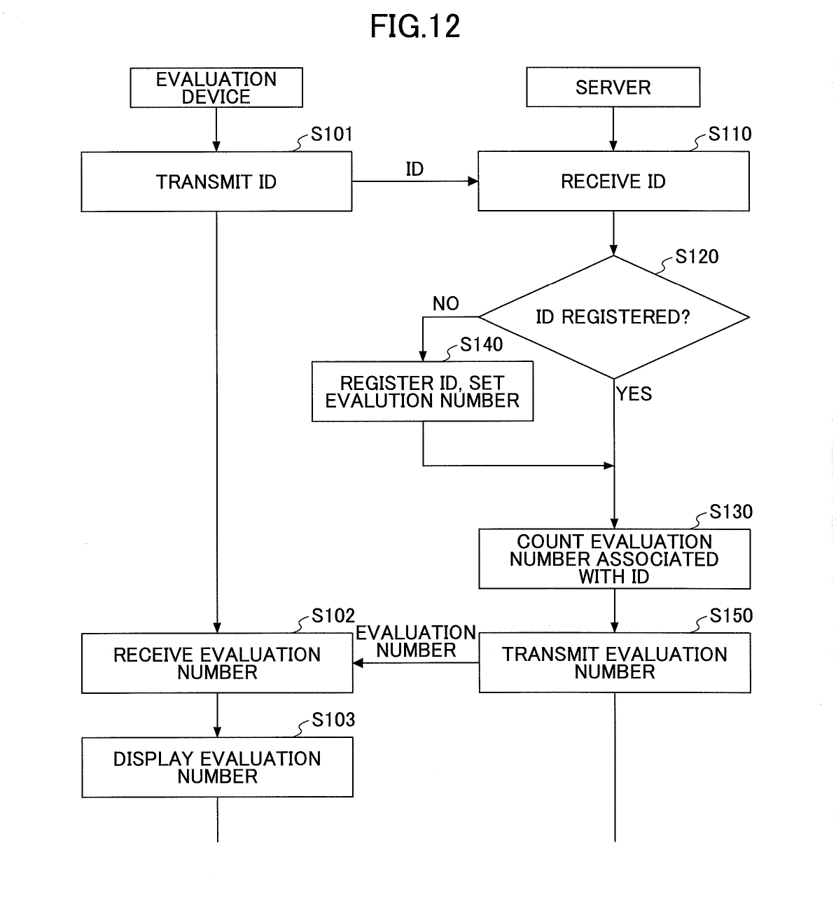

FIG. 12 illustrates a flowchart of a procedure of transmitting an ID from the evaluation device 12 to the server 13 and receiving an evaluation number from the server 13 according to an embodiment of the present invention.

The internet communication unit 32 of the evaluation device 12 transmits an ID to the server 13 (Step S101). It is preferable for the ID to be transmitted together with related data.

The reception unit 23 of the server 13 receives the ID (Step S110).

The ID determination unit 24 determines whether the received ID is stored (registered) in the evaluation data management DB 20 (Step S120). In a case where the server 13 is not involved in the assigning of the ID, the server 13 determines whether the received ID is stored in the evaluation data management DB 20 by also referring to the related data.

In a case where the ID is registered (Yes in Step S120), the evaluation number addition unit 25 increments the evaluation number associated with the registered ID (Step S130). Further, in a case where time data is also received, the evaluation number may be counted in correspondence with a predetermined time period(s). In a case where position data is also received, the evaluation number may be counted in correspondence with a predetermined area(s). Thereby, the evaluation object 11 that is positively evaluated (highly rated) can be identified with respect to each time period or each area.

In a case where a unique number of the evaluation device 12 is transmitted to the server 13, the evaluation number may be counted in correspondence with each unique number (i.e. each evaluation device 12). This allows an incentive (e.g., points) to be granted to the evaluator that affirmatively performs evaluation and provides the evaluation results to the server 13.

In a case where the received ID is not registered (No in Step S120), the ID determination unit 24 newly registers the received ID in the evaluation result table. The evaluation number of the newly registered ID is zero (Step S140).

Then, the evaluation number addition unit 25 increments the evaluation number associated with the ID by 1 (Step S130).

The evaluation data generation unit 28 reads out the evaluation number from the evaluation result table and generates evaluation data including the evaluation number. Then, the evaluation number transmission unit 30 transmits the evaluation data including the evaluation number to, for example, the evaluation device 12 (Step S150).

Then, the Internet communication unit 32 of the evaluation device 12 receives the evaluation number (Step S102).

Then, the evaluation device 12 displays the evaluation number on the display unit 105 (Step S103).

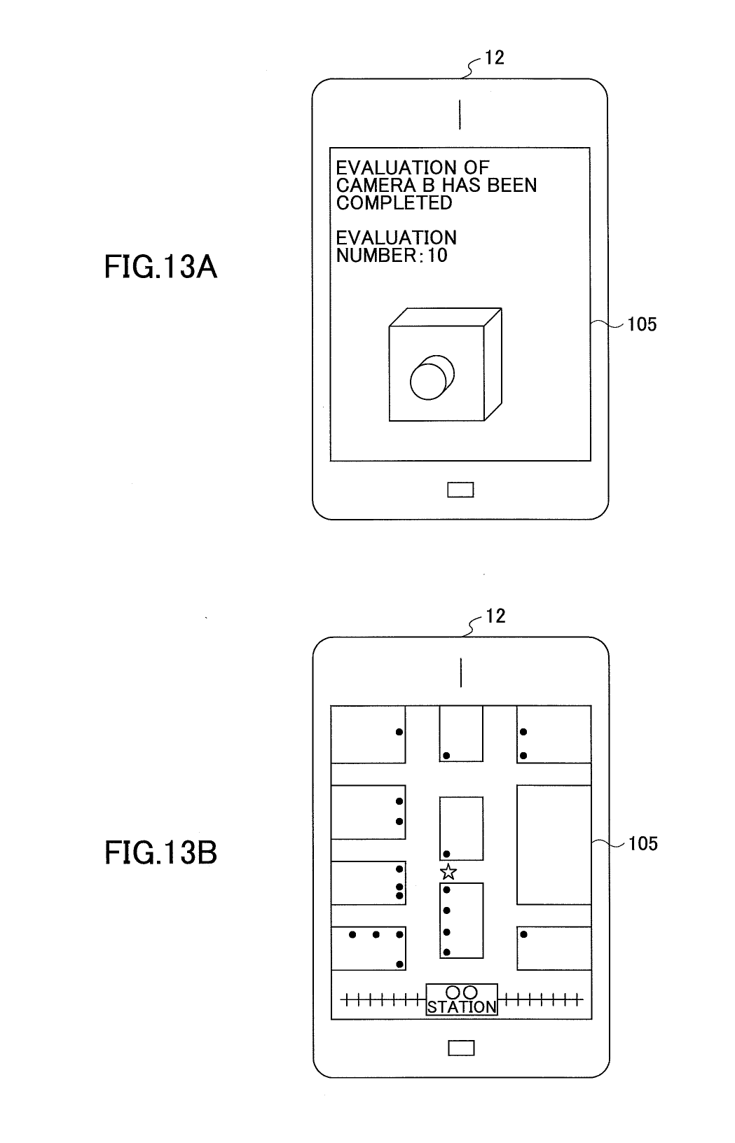

FIG. 13A is a schematic diagram illustrating an example where the evaluation number is displayed in the display unit 105 of the evaluation device 12 according to an embodiment of the present invention. In FIG. 13A, a message “evaluation of camera B has been completed” and a photograph image of the camera is displayed on the evaluation device 12. In this example, “camera B” is a product name. The evaluation device 12 displays the product name “camera B” by receiving data of the product name from the wireless communication chip 15 or from the server 13. The evaluation device 12 displays the photograph image of “camera B” by receiving data of the photograph image from the server 13 or by photographing the camera B with the camera 110. Alternatively, the evaluation device 12 may receive the data of the photograph image from the wireless communication chip 15.

Thereby, the evaluator can confirm that the evaluator's evaluation has been appropriately stored in the evaluation result table immediately after the evaluator has completed evaluation. Further, the evaluator can confirm the evaluation number immediately after the evaluator has completed evaluation.

In a case of transmitting evaluation data from the server 13, the server 13 can transmit the position of the wireless communication chip 13 that is near (e.g., within a radius of 1 km or less) the evaluator based on the position data of the evaluator. Because the position of the wireless communication chip 13 is near the evaluator (within a communicable range of the evaluation device 12), the IDs near the evaluator can be extracted based on the position data included in the related data.

FIG. 13B is a schematic diagram illustrating an example where the position of the wireless communication chip 15 is displayed on the display unit 105 of the evaluation device 12 according to an embodiment of the present invention. In FIG. 13B, the symbol of a star indicates the current position of the evaluation device 12, and the black dots indicate the positions of the wireless communication chips 15. Thereby, the evaluator can evaluate an evaluation object 11 located in the vicinity of the evaluator by referring to the map displayed on the evaluation device 12.

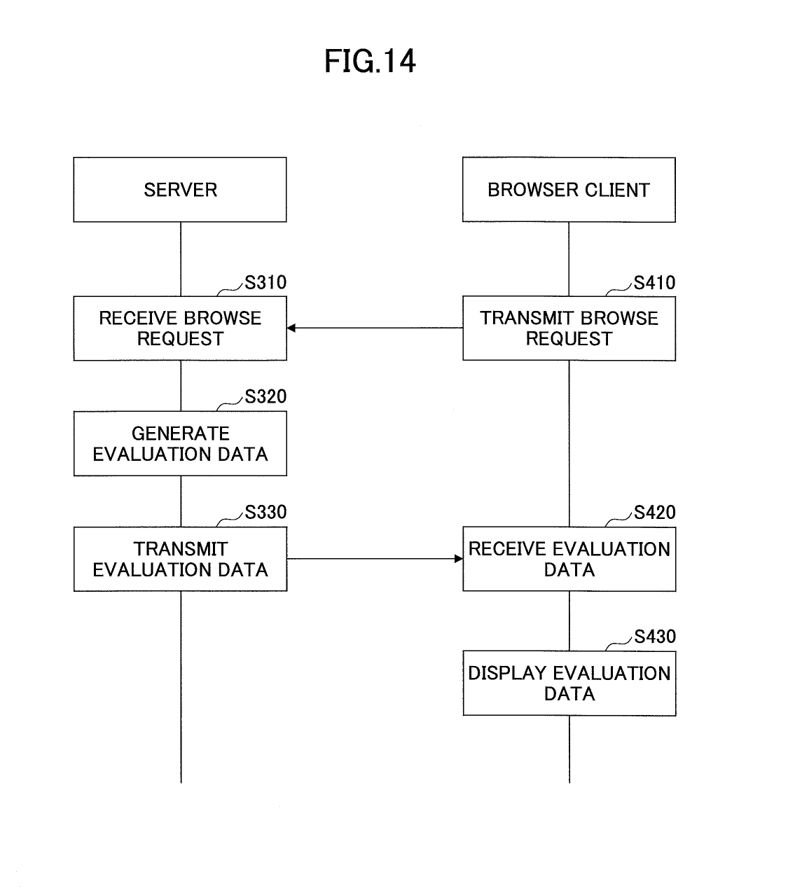

In the examples illustrated in FIGS. 12-13B, the evaluation number is obtained from the server 13 after evaluation is performed with the evaluation device 12. However, the evaluation number can also be browsed with the browser client 14 as described below. FIG. 14 illustrates a flowchart of a procedure of transmitting a browse request from the browser client 14 to the server 13 and receiving evaluation data including an evaluation number from the server 13 according to an embodiment of the present invention. At the beginning of the procedure illustrated in FIG. 14, it is assumed that a top page is already displayed on the browser client 14.

When the browser client 14 receives an input (operation) by the evaluator, the browser client 14 transmits a request to browse the evaluation number (browse request) by using, for example, the ID of the evaluation object 11 as a parameter (Step S410).

Then, the browse request reception unit 27 of the server 13 receives the browse request (Step S310).

Then, the evaluation data generation unit 28 searches for a matching ID from the evaluation result table, reads out the evaluation number of the matching ID stored in the evaluation result table, and generates evaluation data including the ID and the evaluation number (Step S320). The evaluation data may be generated as HTML data. It is also preferable to include the related data of the evaluation object 11 in the evaluation data to be transmitted.

Further, the evaluation data generation unit 28 may also generate the evaluation number that is counted according to a predetermined counting method (e.g., counting the evaluation number with respect to each time period, each area, or each evaluator) included in the browse request. For example, in a case where the evaluator and the user of the browser client 14 (browser) are the same person, the browser can confirm the evaluation number of the evaluation object evaluated by the browser because the browser client 14 is capable of transmitting the unique number or a stored ID to the server 13.

Then, the evaluation data transmission unit 29 transmits the evaluation data to the browser client 14 (Step S330).

Then, the browser client 14 receives the evaluation data (Step S420). Then, the browser client 14 analyzes the HTML data and displays the evaluation data on a display of the browser client 14 (Step S430).

With the above-described embodiment of the evaluation system 500, the evaluator can evaluate the evaluation object 11 by obtaining an ID from the evaluation object 11 with the evaluation device 12 and operating on the evaluation device 12, and confirm the evaluation number of the evaluation object 11. Further, the evaluator can actively evaluate a given product or service (in a reality space).

### Second Embodiment

Next, an evaluation system 500′ according to the second embodiment of the present invention is described. The difference between the evaluation system 500′ of the second embodiment and the evaluation system 500 of the first embodiment is mainly the route for obtaining an ID of an evaluation object.

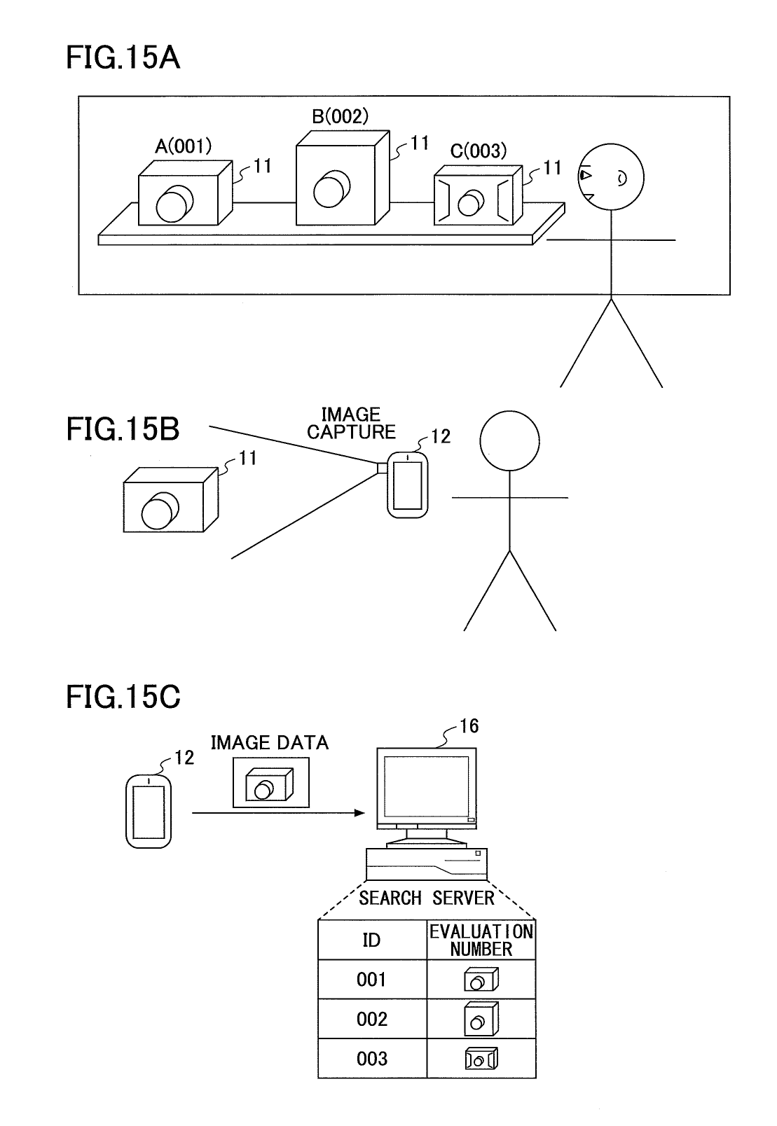

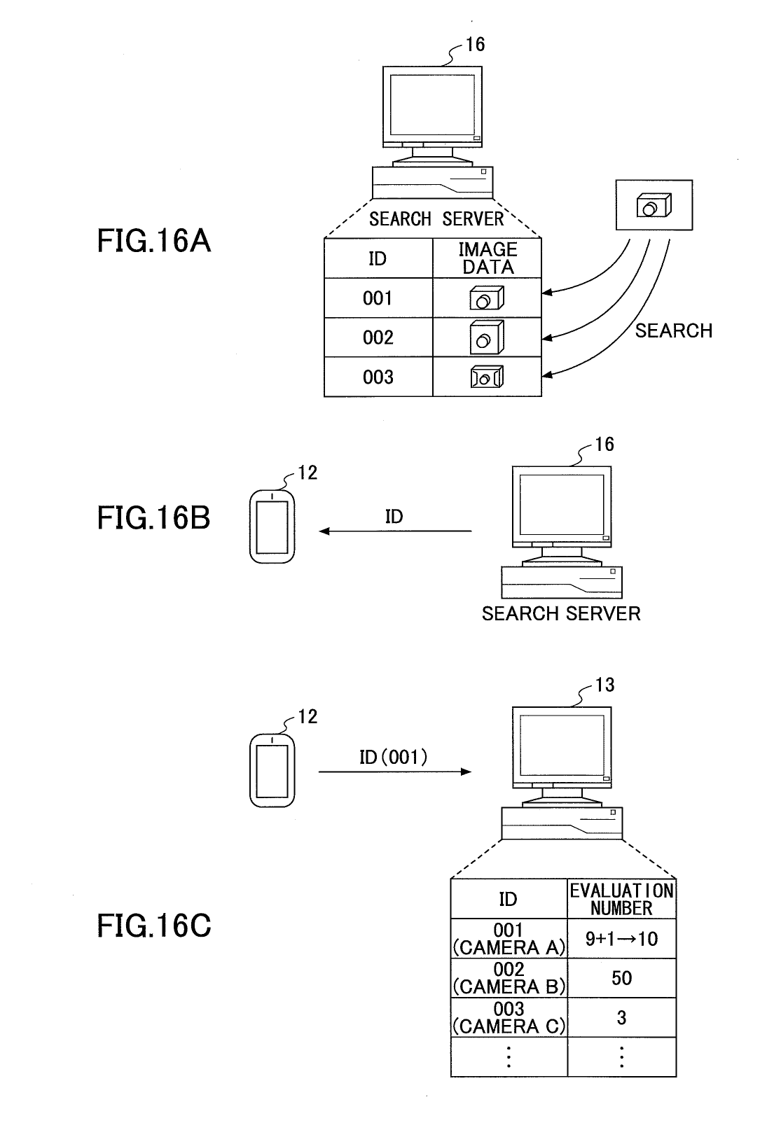

FIGS. 15A-16C are schematic diagrams for describing an evaluation system 500′ according to the second embodiment of the present invention.

In FIG. 15B, an evaluator is carrying an evaluation device 12. The evaluation device is, for example, a portable type communication terminal. In reality, when the evaluator finds an evaluation object 11 of interest while moving (traveling), the evaluator usually slows down or stops.

Then, in a case where the evaluator wishes to evaluate the evaluation object 11 of interest, the evaluator may shoot (e.g., photograph) the evaluation object 11 along with performing a specific action before or after capturing the evaluation object 11. In a case where the evaluation object 11 is a tangible object, an image of the evaluation object 11 can be obtained by directly capturing the evaluation object 11. In a case where the evaluation object 11 is an intangible object such as a service, an image of the evaluation object 11 is obtained by capturing, for example, a tangible object (e.g., a sign) or a place (e.g., shop) that is related to the service.

Then, in FIG. 15C, the evaluation device 12 transmits image data to a search server 16. The search server 16 is a server including an image data database (DB) (or a feature database (DB)) that stores an ID of the evaluation object in association with image data.

Then, in FIG. 16A, the search server 16 searches through the image data DB based on the image data transmitted from the evaluation device 12 and identifies an ID of the image data of the evaluation object 11.

Then, in FIG. 16B, when the search server 16 identifies the ID of the image data, the search server 16 transmits the ID of the image data to the evaluation device 12. Then, the evaluation device 12 transmits the ID to the server 13. The processes performed after the ID is transmitted to the server 13 is substantially the same as those performed after the ID of the evaluation object 11 is transmitted to the server 13 in FIG. 2A of the first embodiment. For example, the server 13 increments the evaluation number of the ID in the evaluation result table.

Accordingly, with the evaluation system 500′ according to the second embodiment, the ID of the evaluation object 11 can be obtained by capturing an image (photographing) with the evaluation device 12 instead of having to receive the ID by establishing communication with the wireless communication chip 15. Similar to the first embodiment, the evaluation system 500′ can also count the evaluation number of the evaluation object 11.

### (Configuration)

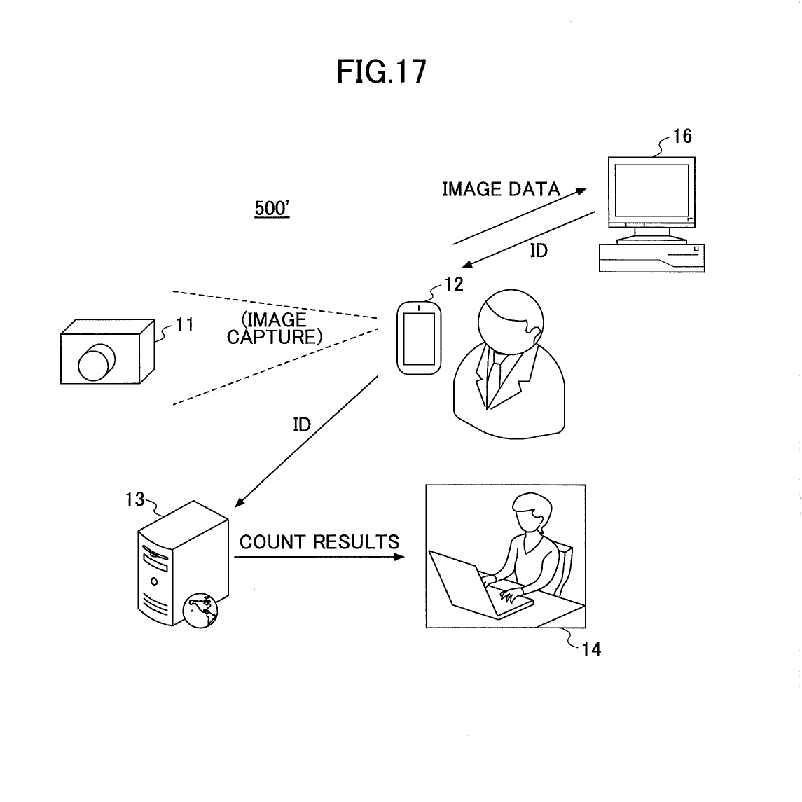

FIG. 17 is a schematic diagram illustrating an example of a configuration of the evaluation system 500′ according to the second embodiment of the present invention. In FIG. 17, like components are denoted with like reference numerals as the reference numerals of FIG. 3 and are not further explained. The evaluation system 500′ includes the evaluation object 11, the evaluation device 12, the server 13, and the search server 16.

In this embodiment, the evaluation object 11 is described as not including the wireless communication chip 15, and the evaluation device 12 obtains an ID from the search server 16. However, the wireless communication chip 15 may be included in the evaluation object 11. Other than not including the wireless communication chip 15, the evaluation object 11 is substantially the same as the evaluation object 11 of the first embodiment.

### (Evaluation Device)

The evaluation device 12 includes a camera 110. The evaluation device 12 is not limited to a particular device as long as the evaluation device 12 can communicate with the server 13 and the search server 16. In a case where the evaluation device 12 is, for example, a smart phone, a tablet, a straight PC, a mobile phone, a PDA (Personal Digital Assistant), or a notebook PC (Personal Computer), the evaluator is likely to carry around the evaluation device 12 quite frequently. Thus, the evaluator is not limited to performing evaluation from only a specific evaluation device 12.

In a case where the evaluator photographs the evaluation object 11, the evaluator is likely to photograph the entire evaluation object 11 or a feature of the evaluation object 11. For example, the evaluator may photograph the evaluation object 11 to include a logo of the evaluation object or the entire evaluation object 11. In a case where the evaluation object 11 is a service, the evaluator may photograph, for example, a sign or an entire facility of a shop that provides the service. Alternatively, in a case where the evaluation object 11 is a tourist site, a view, a place, or a space, the evaluator may photograph, for example, a nearest train station, a nearest bus stop, or a sign for explaining the tourist site. In other words, the evaluator may photograph an attractive view or scenery of the aforementioned tourist site, view, place, or space. Image data of the photographs may be anticipated to be captured by an evaluator and registered (stored) in the search server 16 beforehand.

### (Search Server)

The search server 16 may be a device having a configuration of a common data processing apparatus. The hardware configuration of the search server 16 is substantially the same as the hardware configuration of the server 13 illustrated in FIG. 5.

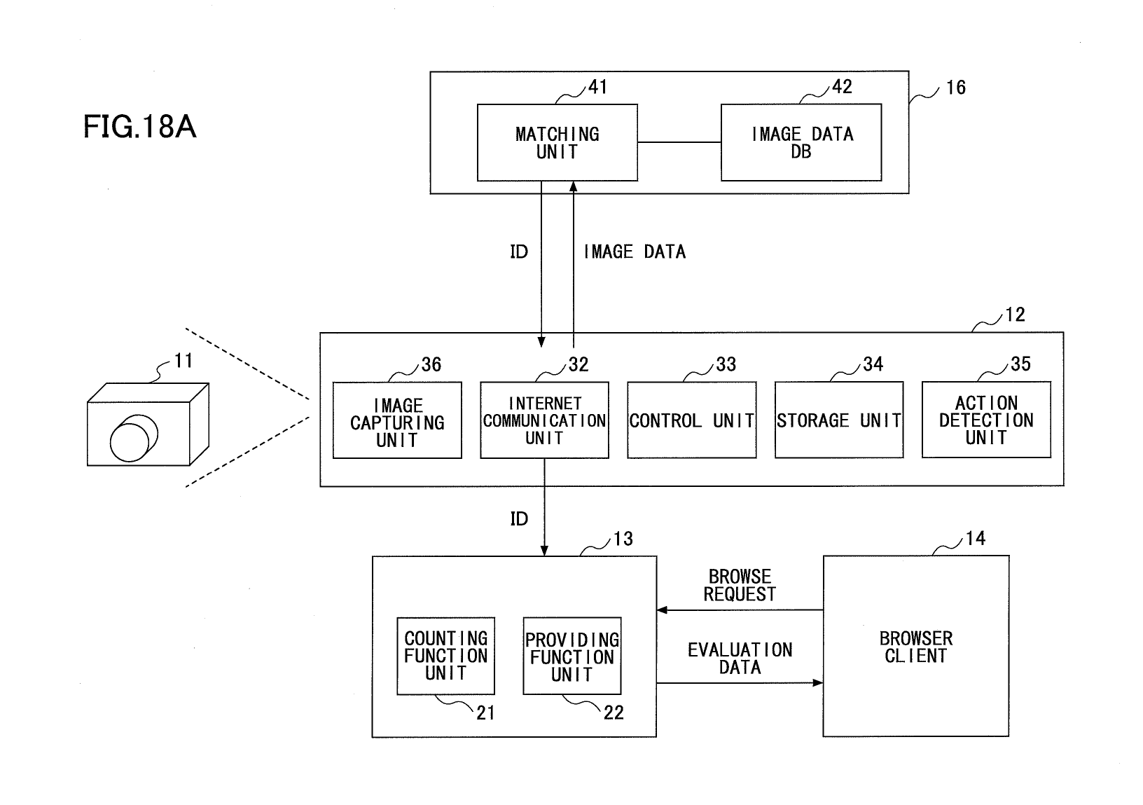

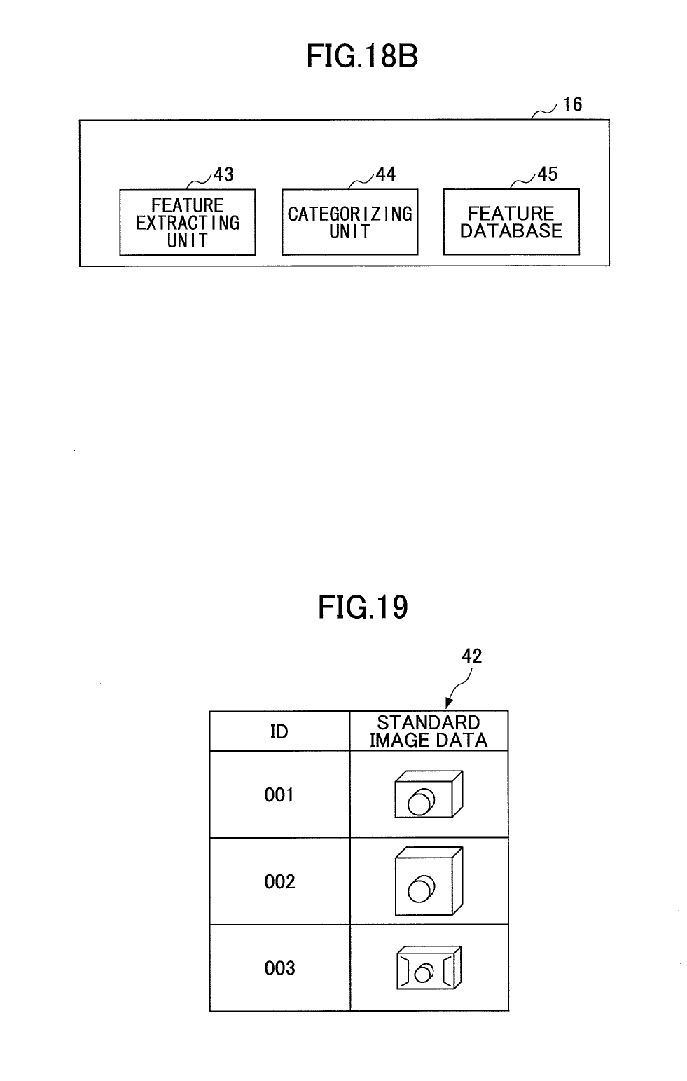

The method used for the communication between the search server 16 and the evaluation device 12 is substantially the same as the communication method used for the communication between the server 13 and the evaluation device 12 described in the first embodiment. Although the server 13 and the search server 16 are illustrated as separate devices in FIG. 17, the server 13 and the search server 16 may be installed in a single data processing apparatus. The search server 16 searches for a image data that matches the image data of the photograph captured with the evaluation device 12 in an image data DB 42 as illustrated in FIG. 18A.

### (Function)

FIGS. 18A and 18B are functional block diagrams for describing the evaluation system 500′ including the evaluation device 12 according to the second embodiment of the present invention. More specifically, FIG. 18A is a block diagram for describing functions (functional units) that are used when the search server 16 performs a pattern matching process, and FIG. 18B is a block diagram for describing functions (functional units) that are used when the search server 16 performs a visual search process. In FIGS. 18A and 18B, like components are denoted with like reference numerals as the reference numerals of FIGS. 6A and 6B and are not further explained. In the second embodiment, the evaluation device 12 is configured to communicate with the search server 16. Because the evaluation object 11 does not need to include the wireless communication chip 15, the evaluation device 12 does not need to include the communication unit 31. However, a capturing (photographing) part 36 is to be included in the evaluation device 12 for photographing the evaluation object 11 with the camera 110.

There are various procedures for receiving an ID based on data of a photographed image. For example, one procedure may be initiated by detection of a specific action by the action detection unit 35. The capturing unit 36 may obtain data of an image of the evaluation object 11 photographed by the camera 110. Similar to the first embodiment, it is preferable to store the time and the position in which the evaluation object 11 is photographed (i.e. time data and position data) in the storage unit 34.

The internet communication unit 32 communicates with the search server 16 by controlling the carrier communication unit 109 and/or the wireless LAN communication unit 108. Thereby, image data can be transmitted to the search server 16. The evaluator may photograph a single evaluation object 11 multiple times. Further, even if the evaluator performs a photographing operation for a single time, the capturing unit 36 may obtain multiple images in response to the single photographing operation. By obtaining multiple images of the evaluation object 11, image data can be searched more easily in the image data DB 42. Therefore, unlike the ID of the first embodiment, in some cases, it may be preferable for the internet communication unit 32 to transmit multiple images of the same evaluation object 11 to the search server 16.

In this embodiment, the action of capturing an image (photographing) can be assumed as a specific action. In a case where the specific action is photographing, the evaluator can obtain an ID of the evaluation object 11 by simply activating the program 114 and photographing the evaluation object 11. Further, in a case where the evaluator desires to perform evaluation after checking the photographed image, the detection of the specific action may be performed on or after the evaluator has checked the photographed image.

The control unit 33 stores the ID received from the search server 16 in the storage unit 34. The control unit 33 transmits the ID stored in the storage unit 34 to the server 13. The processes performed after the ID is transmitted to the server 13 are substantially the same as those performed after the ID of the evaluation object 11 is transmitted to the server 13 of the first embodiment.

Accordingly, the types of procedures using the evaluation device 12 of the second embodiment are as follows.

Procedure 1) Detecting specific action→Photographing→Transmitting image data to search server 16→Receiving ID→Transmitting ID
Procedure 2) Photographing (Detecting specific action)→Transmitting to search server 16→Receiving ID→Transmitting ID
Procedure 3) Photographing→Detecting specific action→Transmitting image data to search server 16→Receiving ID→Transmitting ID

In a case of procedure 1), the specific action may be a gesture action. In this case, the program 114 is activated when the evaluator performs a gesture of vertically shaking the evaluation device 12. Then, the program 114 activates the capturing unit 36. When the evaluator shoots a photograph of the evaluation object 11 with the camera 110, the capturing unit 36 stores image data of the photograph in the storage unit 34. Then, the control unit 33 transmits an ID to the search server 16.

In a case of procedure 2), the evaluator shoots a photograph of the evaluation object 11 in a state where the program 114 and the capturing unit 36 are already active. Then, image data of the photograph is transmitted to the search server 16.

In a case of procedure 3), a given evaluation object 11 is photographed beforehand by the evaluator with the camera 110. Then, in a case where the evaluator decides to perform evaluation by referring to image data of a photograph previously captured with the camera 110, the evaluator activates the program 114 and transmits the image data to the search server 16. The specific action in procedure 3) may be operating on a soft key or a hard key formed by the program 114. It is, however, possible for the image data to be transmitted by a gesture action. For example, image data of a single photograph may be transmitted by performing a gesture action (e.g., shaking the evaluation device 12) once, whereas multiple photographs may be transmitted by performing the gesture action multiples times.

It is to be noted that the order of transmitting/receiving data is not limited to an order of “evaluation device 12→(image data)→search server 16→(ID)→evaluation device 12→(ID)→server 13” but may also be an order of “evaluation device 12→(image data)→search server 16→(ID)→server 13”. In this case, the evaluation device 12 can complete evaluation by simply transmitting image data to the search server 16. Similarly, the evaluation device 12 can also complete evaluation by simply transmitting image data to the search server 16 in a case where the server 13 and the search server 16 are included in the same data processing apparatus.

### (Searching by Search Server)

Next, a searching operation performed by the search server 16 according to an embodiment of the present invention is described. The search server 16 may search for image data using two kinds of methods which are “Pattern matching” and “Visual search (in a case of searching image data of text)”.

### A. Pattern Matching

As illustrated in FIG. 18A, the search server 16 includes a matching unit 41 and an image data DB 42. The image data DB 42 stores an ID in association with a standard image data. The standard image data is image data of various evaluation objects 11 or converted data obtained by converting the image data of the various evaluation objects 11 into feature data. A single standard image data need not be associated to a single evaluation object 11. That is, multiple standard image data may be associated to a single evaluation object 11. For example, image data of plural photographs of a particular evaluation object 11 (e.g., camera) captured from different angles can be assumed as the standard image data. The standard image data may be a photograph that is captured in color or in gray scale.

FIG. 19 is a schematic diagram illustrating an example of the image data DB 42 according to an embodiment of the present invention. In the image data DB 42, one or more standard image data may be associated to a single ID. Although the ID may be the same as the ID described in the first embodiment, the ID of the second embodiment need not be an ID stored in the wireless communication chip 15. The ID of the second embodiment is identification data assigned by the search server 16. This ensures the ID to be unique with respect to a range to which the evaluation system 500′ is applied (e.g., the entire world, a particular country, or a particular area). The ID stored in the image data DB 42 of the search server 16 is stored in the evaluation result table of all of the servers 13.

The matching unit 41 identifies a standard image data having a high correlation with respect to the image data received from the evaluation device 12. Then, the matching unit 41 transmits an ID of the standard image data to the evaluation device 12.

The matching unit 41 performs a preparation process on the image data received from the evaluation device 12. The preparation process may be, for example, a process of enlarging or reducing the size of the image data to match the size of the standard image data, a process of adjusting the color space of the image data to match the color space of the standard image data, a process of adjusting the tone of brightness of the image data to match the brightness of the standard image data, or a process of adjusting the edge of the image data to match the edge of the standard image data.

The matching unit 41 may perform various known pattern matching processes such as SAD (Sum of Absolute Distance), a SSD (Sum of Squared Difference), and a NCC (Normalized Cross Correlation) with respect to each pixel or a pixel block of an image. In a case where the SAD process or the SSD process is used, a value becomes smaller as the correlation becomes higher. In a case where the NCC process is used, a value becomes closer to 1 as the correlation becomes higher.

The matching unit 41 identifies the standard image data having the highest correlation with respect to the image data received from the evaluation device 12. In a case where the correlation of the identified standard image data is equal to or greater than a threshold, the matching unit 41 reads out the ID of the identified standard image data. In a case where there are multiple standard image data having a correlation equal to or greater than the threshold, the IDs of all of the multiple standard image data may be read out.

In a case where there is no standard image data having a correlation equal to or greater than the threshold, the matching unit 41 newly assigns an ID to the image data received from the evaluation device 12 and stores (registers) the image data as a new standard image data in the image data DB 42. Thereby, standard image data can be automatically added to the image data DB 42.

Alternatively, in a case where there is no standard image data having a correlation equal to or greater than the threshold, the matching unit 41 may further search for corresponding image data on, for example, the Internet. The matching unit 41 may obtain one or more image data having high correlation from the Internet and gather object data from obtained image data. Because the image data in the Internet are often written together with data pertaining to, for example, name, provider, and price, the matching unit 41 can gather various object data from the image data obtained from the Internet. The process of searching for corresponding image data and gathering object data may be performed by the server 13.

After identifying the standard image data, the research server 16 transmits the ID of the standard image data to the evaluation device 12. Thereby, similar to the first embodiment, the server 13 increments the evaluation number of the evaluation object 11. Further, related data may be stored together with the ID.

### B. Visual Search

As illustrated in FIG. 18B, the search server 16 includes, for example, a feature extracting unit 43, a categorizing unit 44, and a feature DB 45.

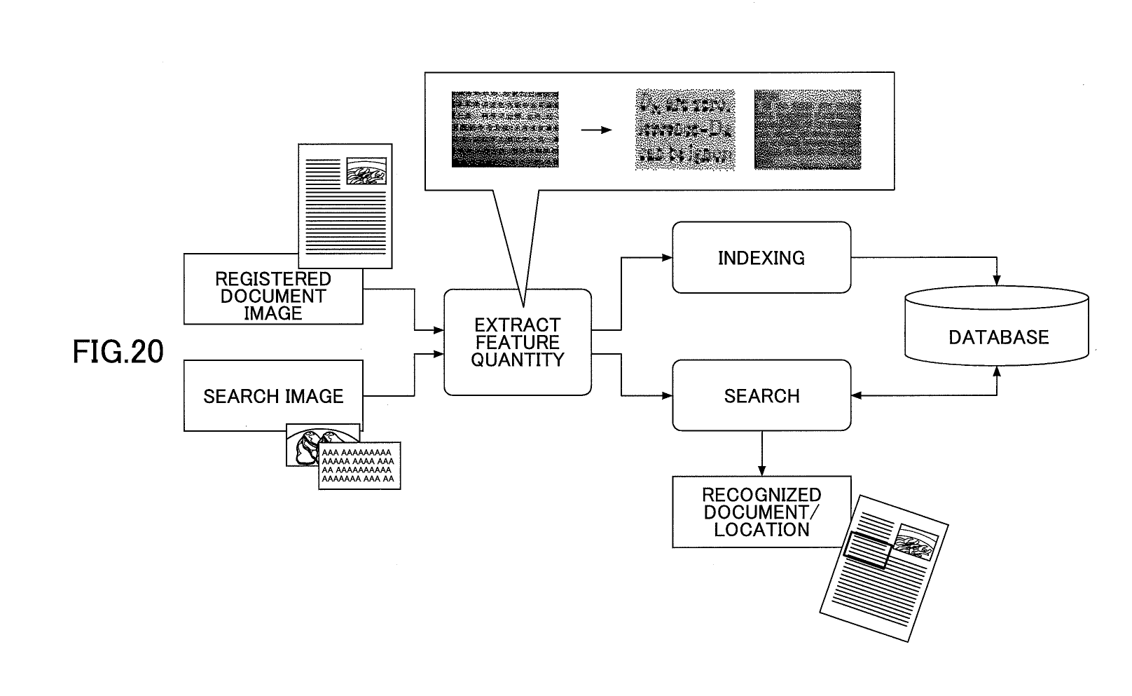

FIG. 20 is a schematic diagram for describing the visual search according to an embodiment of the present invention. The visual search is a process of extracting feature quantities from document images to be compared and comparing the extracted feature quantities of the document images. A registered document image illustrated in FIG. 20 represents a document image whose feature quantities are stored beforehand in the feature DB 45. A search image illustrated in FIG. 20 represents a document image of a photographed document image. The feature quantity is a digitized value of an arrangement of a feature of a text. An index is assigned to the registered document image. This index corresponds to an ID.

For example, in a case where a part of a newspaper article or a magazine article is photographed with the camera 110 of the evaluation device 12, and an image of the photograph is transmitted from the evaluation device 12 to the search server 16, the feature extracting unit 43 extracts a feature(s) from the image transmitted from the evaluation device 12 and compares the extracted features with the features of the registered document image stored in the feature DB 45. Thereby, the search server 16 not only can identify a corresponding registered document image but also identify a particular position in a page of the registered document image.

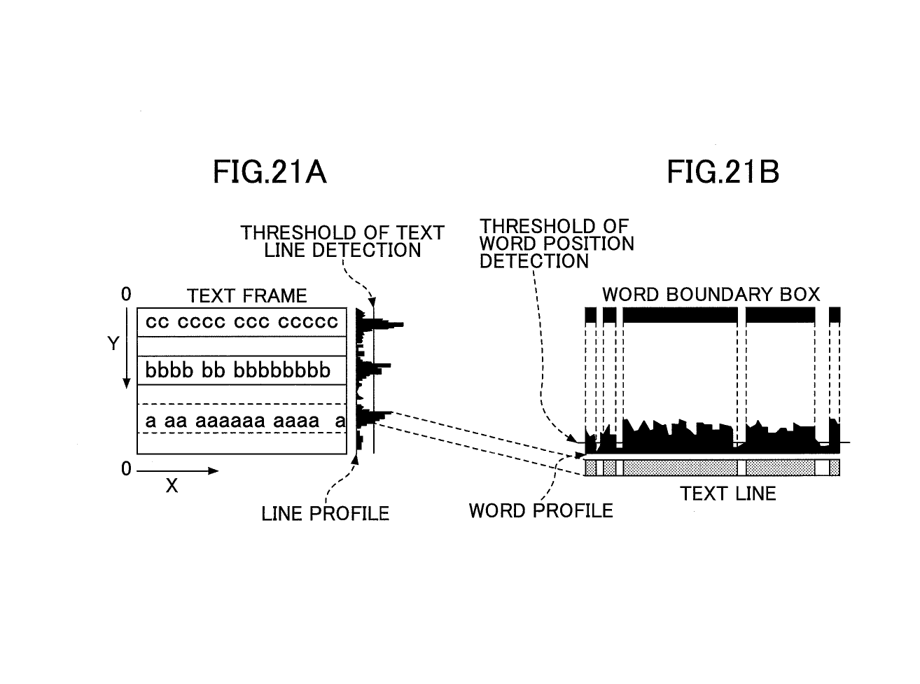

Next, feature quantities are described. FIGS. 21A and 21B are schematic diagrams for describing an example of a word boundary box determination algorithm. In a case where the text of a document image is a language that has spaces in-between words such as English, a word boundary box determination process is performed by determining a boundary of each single word. In a case where the text of a document image is a language having no explicit boundary (space) in-between words such as Japanese, the word boundary box determination process is performed by determining a space which is generated by the presence of a preceding punctuation mark such as a Japanese comma “ [symbol] ” or a Japanese period “∘”.

Then, a skew correction process is performed on the document image. The lines of text of the document image can be aligned in a horizontal direction by the skew correction. As illustrated in FIG. 21A, the feature extracting unit 43 calculates a horizontal projection profile (plan view feature) of the document image. That is, the feature extracting unit 43 calculates a histogram of pixels of the document image in a horizontal direction. In a case where a value calculated from an area (range) in a vertical direction is greater than a threshold, the feature extracting unit 43 determines that the area corresponds to a single line (single row).

After each of the lines constituting the document image is determined (extracted), the search server 16 identifies a word area(s) in each line. As illustrated in FIG. 21B, the feature extracting unit 43 calculates an orthogonal projection profile (plan view feature) of the document image. That is, the feature extracting unit 43 calculates a histogram of pixels of the document image in a vertical direction. In a case where a value calculated from an area (range) in a horizontal direction is greater than a threshold, the feature extracting unit 43 determines that the area corresponds to a single word.

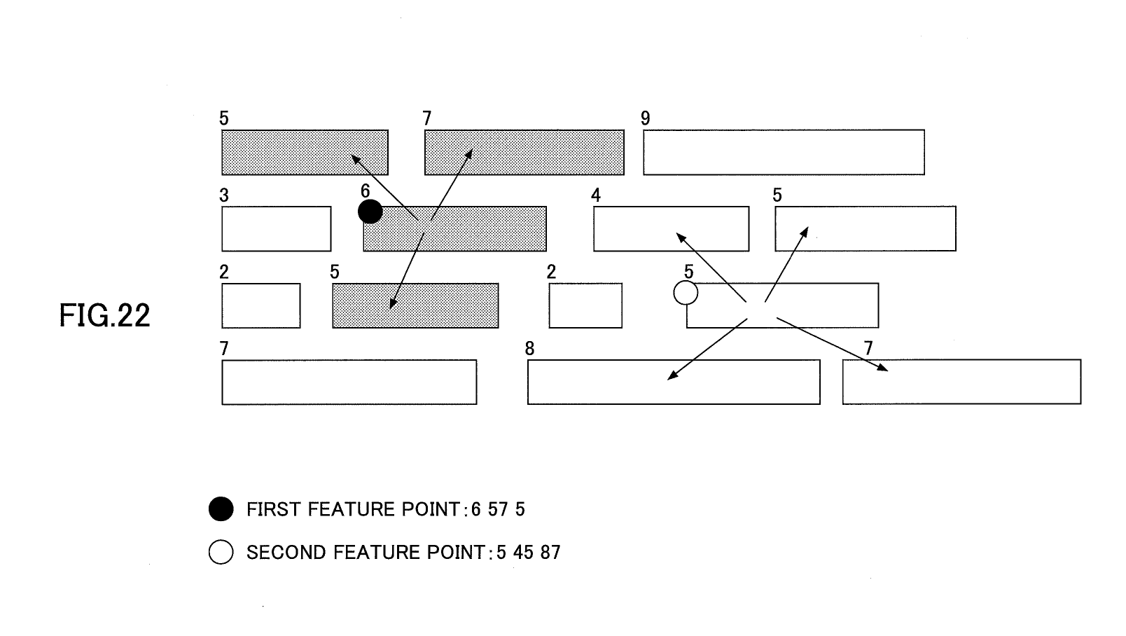

FIG. 22 is a schematic diagram for describing a grouping process based on word boundaries according to an embodiment of the present invention. A bounding rectangle of each of the words determined (detected) by the feature extracting unit 43 corresponds to a word boundary. By determining (extracting) the word boundaries of the document image, multiple groups can be formed from the word boundaries. For example, a group may be constituted by a group of words overlapping in a vertical direction in which the total number of words in a single group is at least three words. For example, in a case where a first feature point is a word box having a length of 6 and being positioned as the second word box in the second row of FIG. 22 (indicated with a black circle in FIG. 22), the first feature point has a front part that overlaps with a first word box of a first row of FIG. 22 having a length of 5 and a rear part that overlaps with a second word box of the first row of FIG. 22 having a length of 7. Further, the front part of the first feature point also overlaps with a second word box of a third row of FIG. 22 having a length of 5.

In a case where a second feature point is a word box having a length of 5 and being positioned as a fourth word box of the third row in FIG. 22 (indicated with a black dot in FIG. 22), the second feature point has a front part that overlaps with a third word box of the second row of FIG. 22 having a length of 4 and a rear part that overlaps with a fourth word box of the second row of FIG. 22 having a length of 5. Further, the front part of the second feature point overlaps with a second word box of a fourth row of FIG. 22 having a length of 8. Further, the rear part of the second feature point overlaps with a third word box of the fourth row of FIG. 22 having a length of 7.

Accordingly, as illustrated in FIG. 22, a feature point is expressed in continuation with the length of the word box positioned above the feature point and expressed with the lengths of the word boxes that overlap with the feature point. In this embodiment, the feature point is assumed as an upper left vertex of the word box. However, the feature point may be another vertex of the word box. Accordingly, the first and the second feature points in FIG. 22 are expressed as follows.

First feature point: 6 57 5
Second feature point: 5 45 87

It is to be noted that the length of the word box may be expressed with any metric unit.

Then, a space(s) of the document image is expressed with “0”, and a word region(s) is expressed with “1”.

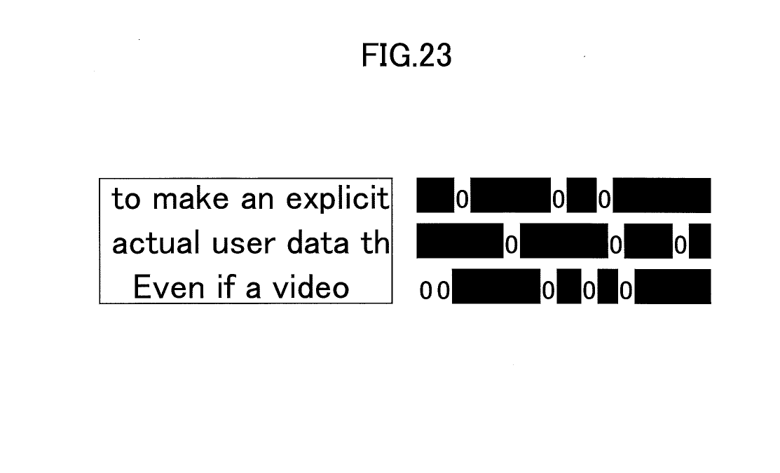

FIG. 23 is a schematic diagram for describing feature quantities including feature quantities “0” and “1” according to an embodiment of the present invention. A block expression illustrated on the right side of FIG. 23 corresponds to the word/space regions of the document image (patch) illustrated on the left side of FIG. 23. That is, the word regions correspond to the black pixels and the space regions correspond to the zeros in FIG. 23.

In this embodiment, the distance between 0 (zero) and 0 (zero) is assumed as a feature quantity. An extracted feature quantity may be compared with various distance indices (e.g., including Norm distance or Hamming distance). Alternatively, a hash table may be used for identifying a document patch (document image) including the same feature quantity as the feature quantity of an image to be searched (query image).

Next, calculation of the angle from one feature point to another feature point is described.

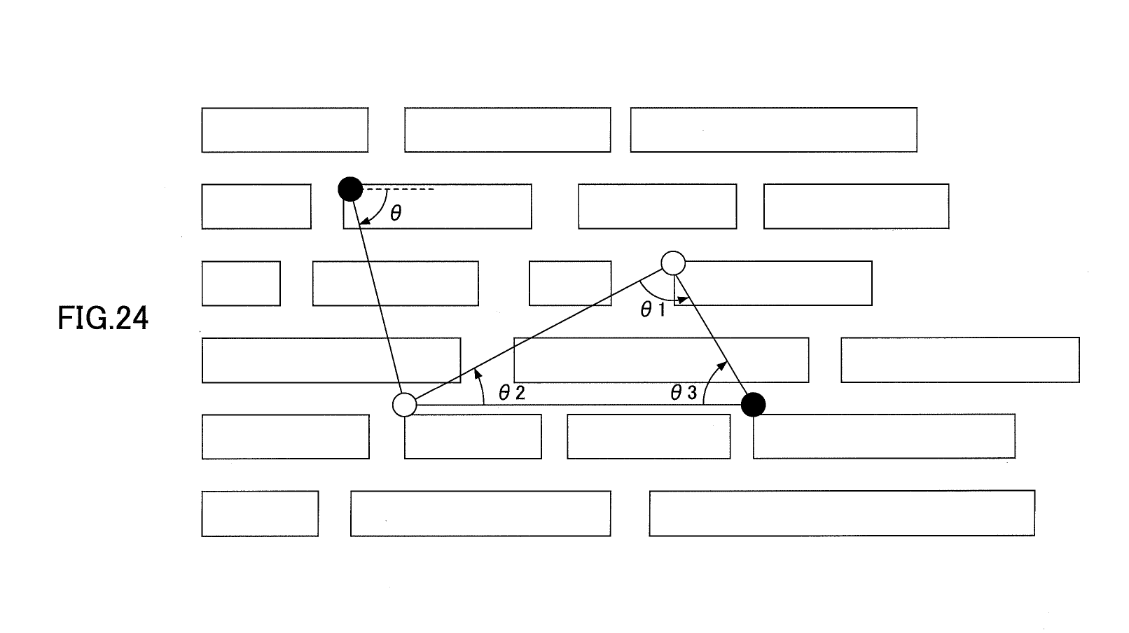

FIG. 24 is a schematic diagram for describing an example of calculating angles formed by word boundaries according to an embodiment of the present invention. More specifically, FIG. 24 illustrates a case of calculating three inner angles θ1 to θ3 in a case where three word boundaries are connected. For example, three or more given word boxes may be extracted for the calculation. Alternatively, the calculation may be performed by connecting the word boundaries constituting a single group obtained in FIG. 22. The method used for determining the word to be searched (query word) may be arbitrary.

The calculated angles are compared with angles that are formed by connecting feature points of the query image to other feature points. For example, in a case where the compared angles formed by the feature points exhibit some kind of similarity, a score of similarity may be increased.

Alternatively, in a case of using groups of angles, a score of similarity may be increased when the values of the angles of feature points of similar groups inside two registered document images are numerically similar. Once the query image and scores among the document images (document patches) are calculated, the feature extracting unit 43 selects a registered document image having the highest similarity score, compares the selected registered document image with an adaptive threshold, and confirms whether the amount in which the registered image data matches the query image fulfills a predetermined standard. In a case where the standard is fulfilled, the feature extracting unit 43 determines that a registered document image matching the query image has been found and reports the determination result to, for example, the evaluation device 12.

In another example, a word length may be used as a feature quantity.

FIG. 25 is a schematic diagram for describing a feature quantity based on word length. With reference to FIG. 25, the feature extracting unit 43 divides each word into multiple estimation letters based on the height and the length of the word. The feature amount is to be registered together with (i) a length of a query word, (ii) a text arrangement of a row above the query word, and (iii) a text arrangement of a row below the query word. The data of the text arrangements is constituted by 1 and 0 to express whether each text of the text arrangement is a space in correspondence with each letter of the query word.

In a case where the number of letters of the query word is six (6 letters), 6 bits of binary numerals are obtained for the text arrangements of ii) and iii). In the example of FIG. 25, the first estimation letter of the text arrangement above the query word is a letter (i.e. not a space), the second and third estimation letters of the text arrangement above the query word are spaces, and the fourth to sixth estimation letters of the text arrangement above the query word are letters. Further, the first to fifth estimation letters of the text arrangement below the query word are letters, and the sixth estimation letter of the text arrangement below the query word is a space. Therefore, the feature quantity of the query word is expressed as (6, 100111, 111110). The query word may be coded into an integer format to be expressed as (6, 39, 62).

Next, an example of matching registered document images with the categorizing unit 44 according to an embodiment of the present invention is described. The categorizing unit 44 extracts the lengths of a group of words or a pair of words that are adjacent to each other in horizontal and orthogonal (vertical) directions and calculates the rankings of each of the registered document data stored in the feature DB 45. This calculation is based on a concept that an image of text includes two independent sources (origins) and that a document can be identified by the arrangement of words in a horizontal direction and the arrangement of words in a vertical direction. In the following example, feature quantities are matched solely based on the lengths of word pairs. However, the matching of feature quantities can be performed in combination with the above-described feature quantities and methods illustrated with FIGS. 22-25.

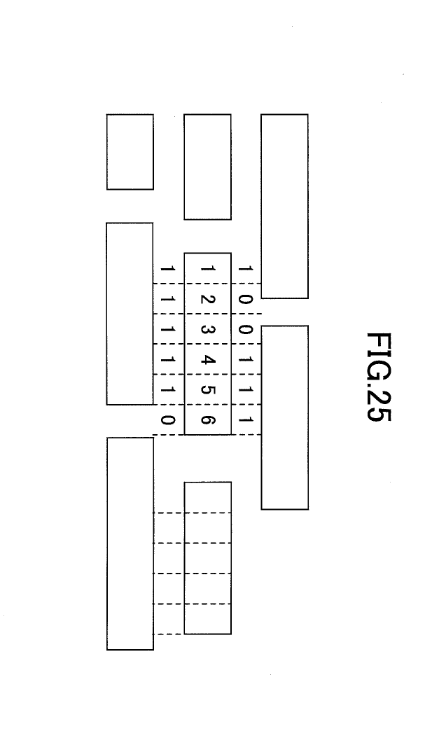

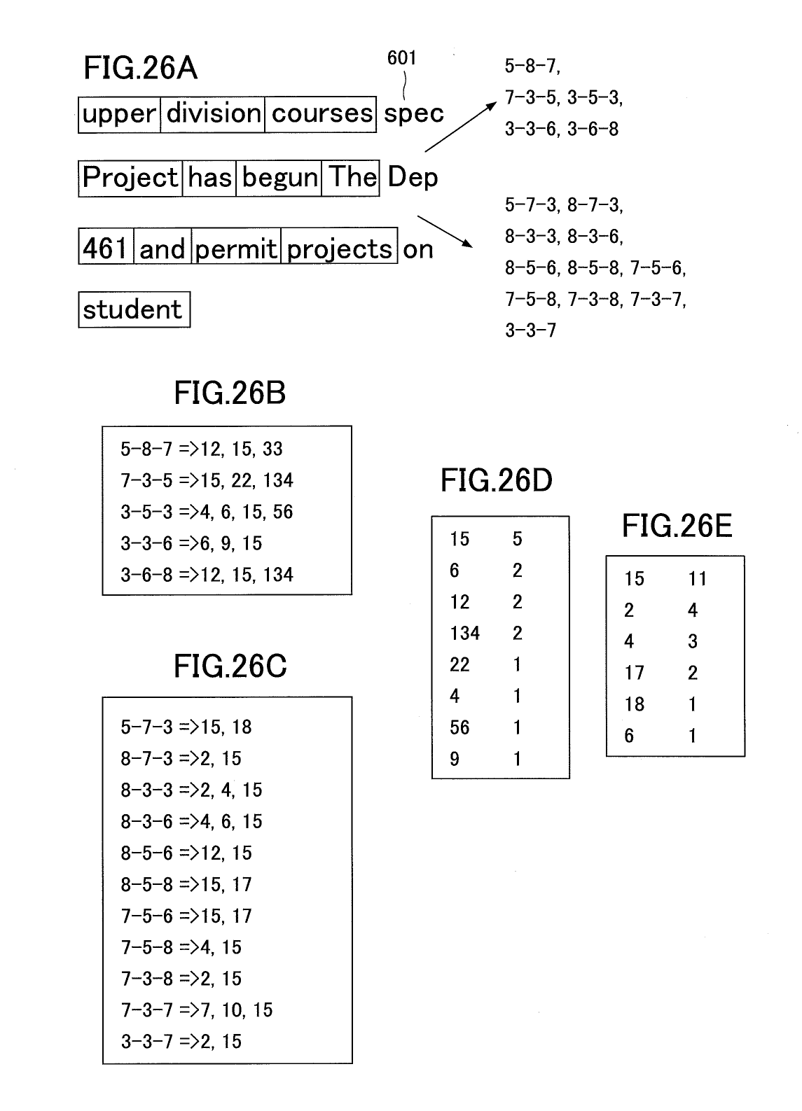

FIGS. 26A-26E are schematic diagrams for describing how a vertical layout is combined with a horizontal layout according to an embodiment of the present invention. FIG. 26A illustrates an example where a document image (patch) 601 is divided into words. Based on the document image 601, a n-gram of a horizontal direction and a n-gram of an orthogonal direction are determined. An “n-gram” is a method for writing a feature quantity with a sequence of “n”. For example, a trigram of a horizontal direction designates the number of characters in each word constituting a horizontal sequence of three words. In the examples of FIG. 26A, the trigrams of the horizontal and vertical directions are shown below.

Horizontal Direction

5-8-7 (“upper”, “division”, and “courses”)
7-3-5 (“Project”, “has”, and “begun”)
3-5-3 (“has”, “begun”, and “The”)
3-3-6 (“461”, “and”, and “permit”)
3-6-8 (“and”, “permit”, and “projects”)

Vertical Direction

8-7-3 (“division”, “Project”, and “461”)
8-3-3 (“division”, “has”, and “and”)
8-3-6 (“division”, “has”, and “permit”)
8-5-6 (“division”, “begun”, and “permit”)
8-5-8 (“division”, “begun”, and “projects”)
7-5-6 (“courses”, “begun”, and “permit”)
7-5-8 (“courses”, “begun”, and “projects”)
7-3-8 (“courses”, “The”, and “projects”)
7-3-7 (“Project”, “461”, and “student”)
3-3-7 (“has” “and” and “student”)

The categorizing unit 44 searches for registered image data including the trigrams of the horizontal and vertical directions from the feature DB 45. FIG. 26B illustrates the search results for the trigrams of the horizontal direction, and FIG. 26C illustrates the search results for the trigrams of the vertical direction. In other words, a horizontal trigram 7-3-5 is found in registered document images having an index of 15, 22, and 134, respectively. Further, a vertical trigram 7-5-6 is found in registered document images having an index of 15 and 17, respectively.

FIG. 26D illustrates a list of the rankings of horizontal trigrams found in the registered document data. The rankings of horizontal trigrams illustrated in FIG. 26D starts from the horizontal trigrams that appear the most in the registered document data. FIG. 26E illustrates a list of the rankings of vertical trigrams found in the registered document data. The rankings of vertical trigrams illustrated in FIG. 26E starts from the vertical trigrams that appear the most in the registered document data. For example, in FIG. 26D, a registered document image having an index of 15 is referred by five horizontal trigrams whereas a registered document image having an index of 9 is referred by only one horizontal trigram. For example, in FIG. 26E, a registered document image having an index of 15 is referred by eleven vertical trigrams whereas a registered document image having an index of 18 is referred by only one vertical trigram.

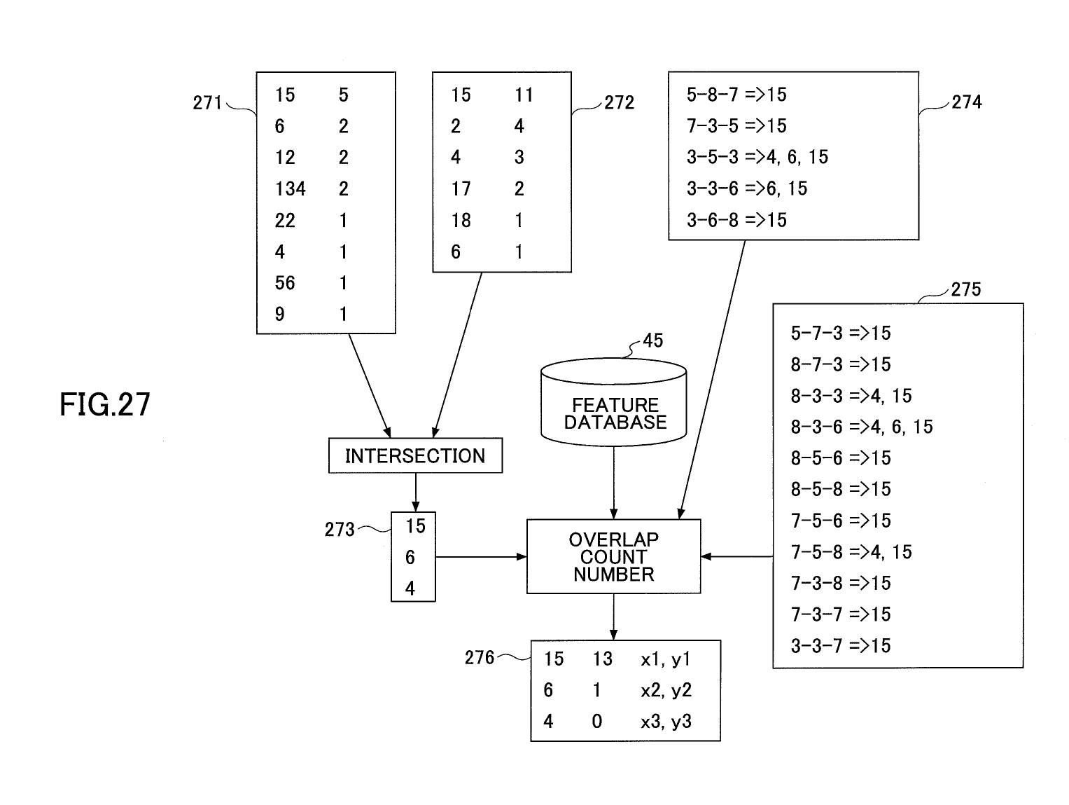

FIG. 27 is an example for describing a method of combining data of the horizontal trigrams and vertical trigrams obtained in FIGS. 26A-26E. The categorizing unit 44 extracts horizontal and vertical features by using, for example, data pertaining to physical locations (positions) of trigrams included in the registered document image. Then, the categorizing unit 44 combines a vote list of the extracted horizontal features and a vote list of the extracted vertical features. That is, among the top M ranking elements obtained from the horizontal trigrams and the top M ranking elements obtained from the vertical trigrams, all of the registered document images that commonly include the top ranking elements are extracted. Then, the locations of all of the horizontal trigrams included in the extracted registered document images are compared with the location of all of the vertical trigrams included in the extracted registered document images. A registered document image that is located (overlapped) in all of the vertical trigrams obtains a vote(s) equivalent to the number of horizontal trigrams included in the registered document image. A case where word boxes (boundary boxes) of two trigrams overlap with each other indicates that at least one of the words included the horizontal trigram overlaps with one of the words included in the vertical trigram.

For example, the categorizing unit 44 generates a list 273 of registered document images that are referred by both the horizontal and vertical trigrams based on lists 271 and 272 illustrated in FIG. 27. The lists 271 and 272 are the same as the lists illustrated in FIGS. 26D and 26E.

A list 274 indicates the results of extracting only the registered document images included in the horizontal trigrams of FIG. 26B from the list 273. A list 275 indicates the results of extracting only the registered document images included in the vertical trigrams of FIG. 26C from the list 273.

The categorizing unit 44 uses the lists 273-275 and the feature DB 45 and determines whether there are any overlaps of document images. For example, a registered document image having an index of 6 is referred by a horizontal trigram 3-5-3 and a vertical trigram 8-3-6. The horizontal trigram 3-5-3 and the vertical trigram 8-3-6 overlap with respect to the word “has” of the document image 601. Thus, the registered document image having the index of 6 obtains one vote because there is one overlap between the horizontal and the vertical trigrams.

Reference numeral 276 indicates the number of votes of the registered document images having the indices of 15, 6, 4, respectively. In the case of document image 601 illustrated in FIG. 26A, the registered document image having the index of 15 has the largest number of votes. Therefore, the registered document image having the index of 15 is determined as the registered document image including the document image 601. In FIG. 27, (x1, y1) is determined as a location of an input image inside the registered document image including the index of 15.

Although trigrams are used for describing the embodiment illustrated FIGS. 26A-26E and FIG. 27, other n-grams may be used for extracting and categorizing horizontal features, vertical features, or both. For example, n-grams (n=4, 5) of horizontal and vertical directions can be used for extracting features of a document image.

It is to be noted that categorization of features does not need to be performed strictly with respect to horizontal and vertical adjacent locations. For example, location indicators such as NW (North West), SW (South West), NE (North East), and SE (South East) may be used for extracting/categorizing features of document data.

Hence, in a case where an evaluator performs evaluation on a photographed text, a text and a location of the text in a page can be identified with high accuracy by using the above-described visual search process. For example, if an ID is assigned to each article of a magazine or each magazine, an evaluator can evaluate (rate) an article in the magazine on the spot when the evaluator highly rates the article. Because the server 13 increments the evaluation numbers associated with the article or the magazine, the rankings of highly rated articles or magazines can be obtained.

### (Operation)

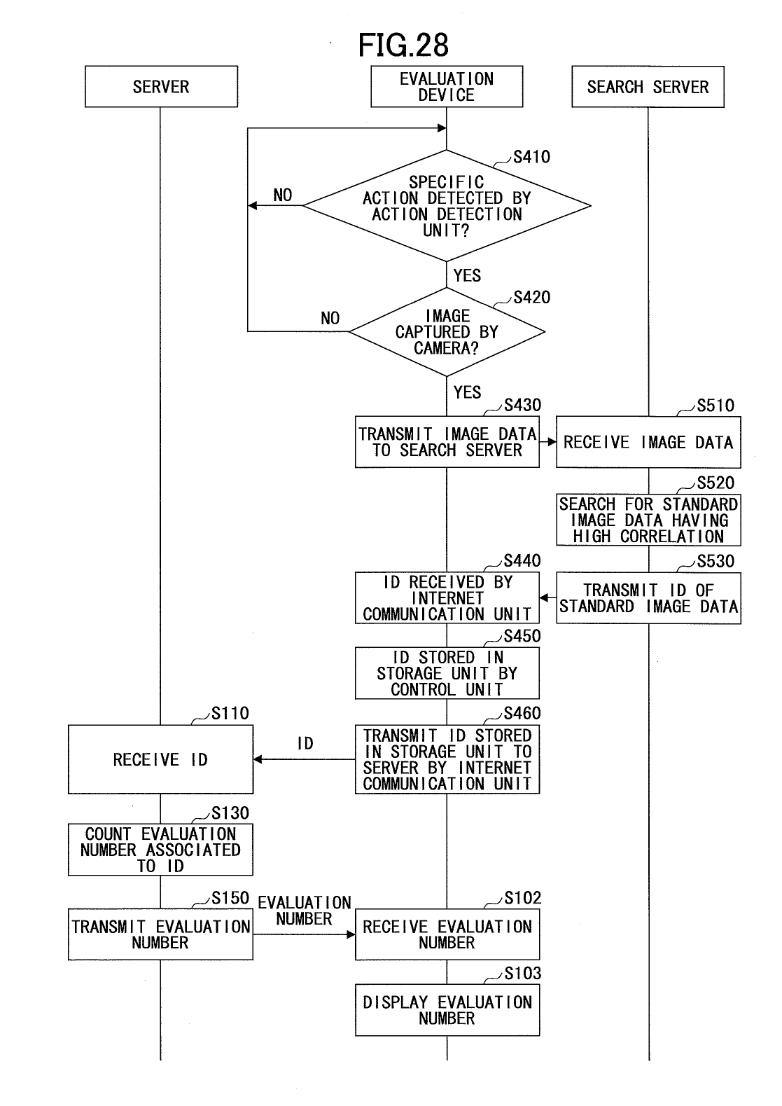

FIG. 28 is a flowchart that illustrates an example of a procedure for transmitting image data from the evaluation device 12 to the search server 16 according to an embodiment of the present invention. In the evaluation device 12, the program 114 is operated for executing the procedures. Although the pattern matching process is performed in the example of FIG. 28, the visual search process may also be used in the example of FIG. 28. FIG. 28 basically corresponds to the above-described procedure 1).

In FIG. 28, first, the action detection unit 35 detects a specific action (Step S410). The program 114 may be activated by the specific action.

When the evaluator operates the evaluation device 12 (camera 110) to photograph the evaluation object 11 (Yes in Step S420), the internet communication unit 32 transmits image data of the evaluation object 11 to the search server 16 (Step S430).

Then, the search server 16 receives the image data transmitted from the evaluation device 12 (Step S510). The matching unit 41 of the search server 16 identifies a standard image data having a high correlation with respect to the transmitted image data (Step S520). The search server 16 transmits an ID of the identified standard image data to the evaluation device 12 (Step S530).

When the internet communication unit 32 of the evaluation device 12 receives the ID transmitted from the search server 16 (Step S440), the control unit 33 stores the ID in the storage unit 34 (Step S450).

Then, the internet communication unit 32 transmits the ID stored in the storage unit 34 to the server 13 (Step S460).

Then, the ID reception unit 23 of the server 13 receives the ID transmitted from the evaluation device 12 (Step S110).

In this embodiment, the ID received from the evaluation device 12 is to be registered in the evaluation result table of the server 13 beforehand. Therefore, the evaluation number addition unit 25 increments the evaluation number associated with the ID by one (Step S130). Further, in a case where time data is also received from the evaluation device 12, the evaluation number may be counted in correspondence with each time period. Further, in a case where position data is also received from the evaluation device 12, the evaluation number may be counted in correspondence with each area. Thereby, the evaluation object 11 having positive evaluation numbers (positive ratings) can be obtained in correspondence with each time period or each area.

In a case where a unique number of the evaluation device 12 is transmitted to the server 13, the evaluation number may be counted in correspondence with each unique number (i.e. each evaluation device 12).

This allows an incentive (e.g., points) to be granted to the evaluator that affirmatively performs evaluation and provides the evaluation results to the server 13.

Then, the evaluation data generation unit 28 reads out an evaluation number from the evaluation result table, generates evaluation data including the evaluation number, and transmits the evaluation data to the evaluation number transmission unit 30 (Step S150).

Then, the internet communication unit 32 of the evaluation device 12 receives the evaluation data from the server 13 (Step S102).

Then, the evaluation device 12 displays the evaluation number on the display unit 105 (Step S103). Thereby, the evaluation device 12 can display the evaluation number as illustrated in FIG. 13A.

In a case where the above-described procedure 2) is used, Steps S410 and S420 are combined as a single step. In a case where the above-described procedure 3) is used, the order of Step S410 and Step S420 are switched.

Hence, with the evaluation system 500′ according to the second embodiment of the present invention, even when the evaluation object 11 includes no ID, the evaluation object 11 can be evaluated by photographing the evaluation object 11. Particularly, because text in a document (e.g., magazine, book) and a position of the text in the document can be searched with high accuracy, the document can be evaluated with high accuracy. It is also to be noted that the first and the second embodiments may be combined.

The present invention is not limited to the specifically disclosed embodiments, and variations and modifications may be made without departing from the scope of the present invention.

The present application is based on and claims the benefit of priority of Japanese Priority Application No. 2012-154273 filed on Jul. 10, 2012, the entire contents of which are hereby incorporated by reference.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can comprise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

What is claimed is:

1. An evaluation system comprising:
an evaluation device including
a detection unit configured to detect a specific action,
an ID (identification data) obtaining unit configured to obtain an ID of an evaluation object according to a detection result of the detection unit,
a first storage unit configured to store the ID obtained by the ID obtaining unit, and
a first communication unit configured to transmit the ID to a server and receive evaluation data of the evaluation object from the server; and
a server including
a second storage unit configured to store the evaluation data of the evaluation object in association with the ID,
a counting unit configured to update the evaluation data of the evaluation object when receiving the ID associated with the evaluation object; and
a transmission unit configured to transmit the evaluation data to the evaluation device.

2. The evaluation system as claimed in claim 1, wherein the evaluation device further includes a display unit configured to display the evaluation data transmitted from the server.

3. The evaluation system as claimed in claim 1,
wherein the communication unit is further configured to transmit at least one of time data, first position data, and a unique number data to the server together with the ID,
wherein the transmission unit is further configured to transmit the evaluation data in correspondence with at least one of a time period, an area, or the evaluation device based on the time data, the first position data, and the unique number data transmitted from the first communication unit, and
wherein the time data indicates a time in which the specific action is detected by the detection unit, the first position data indicates a position of the evaluation device when the specific action is detected, and the unique number data indicates a unique number assigned to the evaluation device.

4. The evaluation system as claimed in claim 3,
wherein the server is further configured to transmit a second position data of the evaluation object positioned a predetermined distance from the evaluation device to the evaluation device in accordance with the first position data transmitted from the evaluation device, and
wherein the display unit is further configured to display the second position data transmitted from the server on a map.

5. The evaluation system as claimed in claim 1,
wherein the counting unit includes an addition unit configured to register the ID in the second storage unit,
wherein in a case where an ID that matches the ID transmitted from the first communication unit is not stored in the second storage unit, the storage unit is configured to store the ID transmitted from the first communication unit in association with the evaluation data, and
wherein the addition unit is configured to increment the evaluation data associated to the ID by 1.

6. The evaluation system as claimed in claim 1, wherein the evaluation device further includes a second communication unit configured to establish wireless communication with the evaluation object and receive the ID from the evaluation object.

7. The evaluation system as claimed in claim 1, further comprising:
another server;
wherein the evaluation device further includes
a capturing unit configured to capture an image of the evaluation object, and
a second communication unit configured to transmit image data obtained by the capturing unit to the another server, and
wherein the another server includes
a third storage unit configured to store the image data or a feature amount of the image data in association with the ID, and
another transmission unit configured to transmit the ID associated to the image data or the feature amount, to the evaluation device.

8. A method for evaluating an evaluation object with an evaluation device, the method comprising the steps of:
detecting a specific action;
obtaining an ID (identification data) of the evaluation object according to a detection result of the detection step;
storing the ID obtained by the obtaining step;
transmitting the ID stored in the storing step to a server;
receiving evaluation data of the evaluation object from the server;
storing the evaluation data of the evaluation object in association with the ID;
updating the evaluation data of the evaluation object when receiving the ID associated with the evaluation object; and
transmitting the evaluation data to the evaluation device.

9. A non-transitory computer-readable recording medium on which a program is recorded for causing a computer to execute a method for evaluating an evaluation object with an evaluation device, the method comprising the steps of:
detecting a specific action;
obtaining an ID (identification data) of the evaluation object according to a detection result of the detection step;
storing the ID obtained by the obtaining step;
transmitting the ID stored in the storing step to a server;
receiving evaluation data of the evaluation object from the server;
storing the evaluation data of the evaluation object in association with the ID;
updating the evaluation data of the evaluation object when receiving the ID associated with the evaluation object; and
transmitting the evaluation data to the evaluation device.
